(19) United States
(12) Patent Application Publication
(10) Pub. No.: US 2017/0217847 A1
(43) Pub. Date: Aug. 3, 2017

(54) METHOD FOR CONTROLLING NUTRIENT DEPLETION FROM AGRICULTURAL SOILS

(71) Applicant: Actagro, LLC, Fresno, CA (US)

(72) Inventors: Thomas J. Gerecke, Fresno, CA (US); Gregory A. Crawford, Fresno, CA (US); Husein Ajwa, Fresno, CA (US); Montell L. Bayer, Fresno, CA (US); John Breen, Fresno, CA (US); Taha Rezai, Fresno, CA (US)

(21) Appl. No.: 15/501,427

(22) PCT Filed: Aug. 4, 2015
(86) PCT No.: PCT/US2015/043645

§ 371 Date: Feb. 2, 2017

Related U.S. Application Data
(60) Provisional application No. 62/032,867, filed on Aug. 4, 2014.

(51) Int. Cl. C05F 11/02; C05F 11/00

(52) U.S. Cl. CPC C05F 11/02; C05F 11/00

(57) ABSTRACT

This disclosure relates to a method for controlling nutrient depletion and reducing nitrogen and phosphorus run-off in agricultural applications. It is contemplated that the methods described herein maintain more available nitrogen and phosphorus in the plant root zone and minimize premature leaching and loss of the plant nutrients into surface waters and the subsurface ground water. The nutrient depletion-restricting substance includes a liquid formulation comprising one or more of the following components: (1) a plant extract from algae, seaweed, or their derivatives; (2) a liquid plant growth modification composition (3) a humic extract from a genuine humic source, e.g., leonardite.

### CROSS-REFERENCE TO RELATED APPLICATIONS

This application claims the benefit under 35 U.S.C. §119 of U.S. Application No. 62/032,867, filed Aug. 4, 2014, the contents of which is incorporated herein by reference by its entirety.

### FIELD

This disclosure relates to a method for controlling nutrient depletion in soil and reducing nitrogen and phosphorus runoff in agricultural applications.

### BACKGROUND

Agricultural fertilizers commonly include the active ingredients nitrogen and phosphorus. After fertilizer is applied to the soil of an agricultural field, these constituents are often prematurely depleted, which can have detrimental effects on the environment and significantly reduce the pool of available nutrients.

A schematic of the nitrogen cycle in soil is shown in FIG. 7. A principle cause of nitrogen loss is surface volatilization. This occurs proximate to the surface of the soil. Urea is a major nitrogen fertilizer. Urea nitrogen reacts with urease enzyme in the soil and break down to form ammonia gas. At or near the surface, there is typically little amount of soil water to absorb these gases and, as a result, they escape into the atmosphere. This condition worsens when the urea forms of nitrogen are applied to the field but are not in direct contact with the soil, such as when urea is spread on corn residues or urea ammonium nitrate solution is sprayed on heavy residues of corn stalk or a cover crop. The rate of surface volatilization typically depends on the moisture level, temperature and surface pH of the soil. If the soil surface is moist, water in the soil evaporates into the air. Ammonia released by the urea is captured by the water vapor and lost into the atmosphere. Air temperatures greater than 50° F. and a soil pH greater than 6.5 significantly increase the rate of urea conversion to ammonia gases and resultant surface volatilization.

In certain applications, gaseous ammonia is applied to the soil of an agricultural field by metal application shanks that are introduced into the soil. If the soil is not thoroughly covered and packed behind the shanks, ammonia gas and its constituent nitrogen are lost from the soil surface before being absorbed into the soil water and converted to ammonium, which adsorbs to the soil particles.

Surface volatilization of nitrogen can also occur when ammonium forms of nitrogen (e.g., ammonium sulfate, di-ammonium phosphate, etc.) are applied to the surface of calcareous soils having a pH greater than 7.5. The reaction products formed when such ammonium fertilizers react with calcium carbonate tend to volatilize and dissipate into the atmosphere.

Another cause of nitrogen depletion from agricultural fertilizers is denitrification. This occurs when nitrate (NO₃⁻) is present in the soil, but not enough oxygen is present to supply the needs of the bacteria and microorganisms in the soil. If oxygen levels are too low, such microorganisms strip the oxygen from the nitrate. This produces nitrogen gas (N₂) or nitrous oxide (N₂O), which volatilize readily from the soil. Denitrification increases when the soil is wet or compact or when excessively warm temperatures are encountered.

Leaching of nitrate is yet another cause of unwanted nitrogen loss. This occurs when the soil receives more incoming water (by either rain or irrigation) than it can hold against the force of gravity. As water migrates downward though the soil, nitrate-N, which is water soluble, moves with the water and is lost into the groundwater, from where it cannot travel against gravity back up into the soil profile. Although ammonium (NH₄) forms of nitrogen tend to leach very little in most soils, ammonium leaching can be significant in coarse-textured sands and some muck soils.

Both nitrogen and phosphorus can also be subject to premature depletion through runoff.

Such runoff tends to occur when the soil receives more incoming water through rain or irrigation than the soil can accommodate. As water moves over the soil, some of the soil may be loosened and move with the water. The excess water can then carry the dislodged soil and any adsorbed fertilizer nitrogen and phosphorus away from the agricultural site. The offsite movement of such nitrogen and phosphorus due to runoff can be particularly severe in sloped or hilly terrains.

The depletion of nitrogen and phosphorus described above presents a number of problems and disadvantages. Because a significant portion of the plant-enhancing nutrients are lost, many agricultural fertilizer treatments tend to be inefficient and not optimally effective. A considerable amount of the active nitrogen and phosphorus nutrients applied to the field are wasted, plant growth may be slowed and/or an inferior crop may result. Applying additional fertilizers to make up for the nitrogen/phosphorus depletion can add considerable cost, both to the grower and to the consumer. Another problem associated with depletion of nitrogen and phosphorus from agricultural fertilizers is the adverse environmental effects that frequently result. In particular, leaching of nitrates and urea as well as runoff of nitrogen and phosphorus-bearing sediments can contaminate and pollute nearby surface water (e.g., streams, rivers, lakes, ocean, etc.) and ground water (e.g., aquifers). Nitrate leaching is a significant environmental problem, because above certain levels, nitrate in drinking water is toxic to humans.

In addition, volatile nitrogen oxides, such as nitrous oxide (N₂O), are known to be contributors to greenhouse gas (GHG), which can adversely affect the environment. Fertilizer runoff can cause phosphorus pollution of surface waters. When the amount of fertilizer applied to a site is increased to compensate for depletion, this only adds to the volume of potentially polluting crop nutrients introduced into the environment.

### SUMMARY

The present disclosure relates to methods for controlling the depletion rate of nutrients in soil. In addition, the method also greatly reduces the adverse environmental impact previously caused by such fertilizers.

Accordingly, provided herein is a method for controlling the depletion rate of a nutrient in soil, comprising applying a nutrient depletion-restricting substance (hereafter referred to as “NDRS”) and a fertilizer to soil or applying a NDRS to soil which has been fertilized, wherein the depletion of the nutrient is reduced by about 40 to about 80% by weight. In one embodiment, the depletion of the nutrient is reduced at about 30 hours after applying the fertilizer to the soil.

In certain embodiments, the method controls nutrient depletion from agricultural fertilizers by reducing one or more of: (i) ammonia (or nitrogen) volatilization, (ii) nitrogen loss due to denitrification, (iii) nitrogen loss due to nitrate leaching, (iv) nitrogen adsorption at the surface of the soil (v) attendant surface runoff, and/or (vi) a larger pool of nitrogen uptake by the crop, and hence not available to be lost by the other mechanisms described. In certain embodiments, the nutrient is nitrogen or a nitrogen component and/or phosphorous or a phosphorous component.

In one embodiment is a method of inhibiting nitrogen volatilization from soil, comprising applying a nutrient depletion-restricting substance (NDRS) and a fertilizer to soil or applying a NDRS to soil which has been fertilized, wherein the amount of nitrogen loss via volatilization is reduced by at least about 40% by weight after about 7 days after applying the nitrogen-based fertilizer at a temperature of about 15-30° C.

In one embodiment, provided herein is a method for restricting nutrient depletion in agricultural fields, turf and sod grass farms and other planting sites.

As such, provided herein is a method for stabilizing nitrogen in an agricultural fertilizer such that it remains in the vicinity of a plant's root zone. In one aspect, provided is a method for reducing the volume of fertilizer conventionally required to effectively fertilize an agricultural field or other planting site.

In a further aspect, provided is a method of increasing nitrate immobilization and/or mineralization in soil by at least about 25% after about 100 days. In certain embodiments, the method comprises applying a NDRS to soil at a concentration of at least about 0.1 milligrams of NDRS per 100 grams of soil.

In a further aspect, provided is a method for limiting the risk of nitrogen and phosphorus contamination of the environment that has previously accompanied the use of agricultural fertilizers. Thus, provided herein a method for reducing the amount of fertilizer needed to effectively sustain an agricultural field or other planting site without creating an undue risk of polluting the nearby environment and, in particular, nearby surface and ground water.

In a further aspect, provided is a method of decreasing nitrate leachate from soil by at least about 50% after about 3 weeks. In certain embodiments, the method comprises applying NDRS to soil at a concentration of at least about 0.1 mg of NDRS per 100 grams of soil.

In another aspect, provided is a method for increasing nitrogen uptake within a crop, comprising applying a NDRS and optionally a fertilizer to soil or applying a NDRS to soil which has been fertilized. In certain embodiments, the weight of nitrogen contained in the biomass of the crop is increased by least about 15% by weight versus the weight of nitrogen contained in the biomass of a crop where a NDRS was not applied to the soil.

In yet another aspect, provided is a method of inhibiting nitrogen volatilization from soil, comprising applying a NDRS and a nitrogen-based fertilizer to soil or applying a NDRS to soil which has been fertilized. In certain embodiments, the amount of nitrogen loss via volatilization is reduced by at least about 40% by weight after about 7 days after applying the NDRS and/or nitrogen-based fertilizer.

In one embodiment, the disclosure relates to a method for reducing water and/or air pollution caused by the use of a fertilizer in soil, comprising applying a NDRS and a fertilizer to the soil. In one embodiment, disclosed herein is method for inhibiting and/or mitigating transformation of nitrate (NO₃−) and/or ammonium (NH₄+) to nitrogen or ammonia gas, comprising applying a NDRS to a soil, optionally in the presence of a fertilizer. In certain embodiments, the NDRS is applied to the soil within a time period of from about 3 hours before to about 3 hours after applying the fertilizer. In some embodiments, the amount of fertilizer applied to the soil is decreased by at least about 50%.

In one embodiment, the disclosure is directed to methods for reducing a variety of nutrient depleting factors through the use of a single formulated product rather than using a variety of different products that are each directed to a respective problem.

Disclosed herein is a method for controlling or reducing nutrient depletion from fertilizer applied to an agricultural field or other planting site. An agricultural fertilizer, which may include a nitrogen and/or phosphorus based fertilizer is applied to the soil of the site. In certain embodiments, the fertilizer is applied to the soil at a rate of at least about 50% less, or about 50% less, or about 40% less, or about 30% less, or about 25% less or about 20% less than is used in the absence of a NDRS, in order to achieve substantially the same result (e.g., reduced nitrogen volatilization, etc.). At substantially the same time, or immediately prior to or thereafter (e.g., within a time period of about 3 hours before or after), a nutrient depletion-restricting substance is applied to the field. In one embodiment, the nutrient depletion-restricting substance includes a liquid formulation comprising one or more of the following components:

(1) a plant extract from algae, seaweed, or their derivatives;

(2) a liquid plant growth modification composition of the type produced by the methods described in U.S. Pat. Nos. 4,698,090 and 4,786,307, issued to Marihart; and/or

(3) a humic extract from a genuine humic source, e.g., leonardite.

In one embodiment, two or all three of the foregoing constituents are included in the nutrient depletion-restricting substance.

By applying a NDRS and a fertilizer, in solution or otherwise in a relatively contemporaneously manner, to the agricultural field or planting site, ammonia volatilization, denitrification and nitrate leaching losses are all significantly reduced and improved nitrogen absorption in the vicinity of the root zone is achieved. By the same token, surface runoff of nitrogen and phosphorus are significantly reduced. As a direct result of reduced depletion, a greater percentage (e.g., up to about 25% more) nutrients are available for use by the plants. In addition, environmentally damaging runoff of nitrogen and phosphates is significantly mitigated and release of GHGs (greenhouse gases) is reduced.

Application of the NDRS may be done once or throughout various times of the crop cycle. For example, in annual crops, there is either one application around planting time or the application may be split throughout the growing season. In one embodiment, the applications are split up through the mid-reproductive phase. In one embodiment to perennial crops, the application may be done at various times from bud break until dormancy (e.g., throughout the year).

Other features and advantages will occur from the following description and the accompanying drawings.

### BRIEF DESCRIPTION OF THE DRAWINGS

FIG. 1 is a graph illustrating levels of ammonia volatilization that occurs in two test soils applied respectively with urea alone, urea fertilizer in combination with a first NDRS and urea fertilizer in combination with a second NDRS.

FIGS. 2-4 are graphs reflecting nitrate concentrations and related levels of nitrogen leaching that occur in a selected soil sample over time when fertilization is performed using a control fertilizer solution and various solutions containing both the fertilizer and a NDRS; results are provided for two application rates of the respective NDRS.

FIGS. 5 and 6 are graphs of data derived from respective soils applied with an untreated ammonium nitrate and water control solution and two ammonium nitrate solutions containing NDRS; the graphs indicate CO₂ evolution and attendant microbial growth, which represents nitrogen stabilization and potential usage by crops planted in the respective soils over time.

FIG. 7 is a schematic describing the nitrogen soil cycle.

FIG. 8 (panels a-c) show the NH₃ volatilization as measured after treatment by two

NDRS compositions in soils collected from (a) Tulare; (b) Kern and (c) Monterey. FIG. 8 indicates that treatment with the mixture of urea and nutrient depletion-restricting substances OA-4 and OA-9 caused a significant reduction in the amount of ammonia released to the atmosphere over time.

FIG. 9 (panels a-c) show the cumulative nitrogen mineralization as measured by −concentration in leachate from three soils (a: Kern, b: Monterey, c: Tulare).

FIG. 10 (panels a-c) show the carbon mineralization with and without NDRS at the low rate from three soils (a. Tulare, b. Kern, c. Monterey).

FIG. 11 (panels a-c) show the carbon mineralization with and without NDRS at the high rate from three soils (a. Tulare, b. Kern, c. Monterey).

FIG. 12 compares urea dialysis in control and OA-4 Solutions.

FIG. 13 shows the average equilibrium urea concentration in the counter buffer at 26, 28, 30, 32, and 34 hours.

FIG. 14 (panels a-d) show the nitrogen transformations after application of 50 mg ¹⁵N/kg as K₂N0₄ to various soils. a. Kern, b. Fresno, c. Monterey d. Tulare.

FIG. 15 shows the nitrogen transformations after application of 50 mg ¹⁵N/kg as (NH₄)₂SO₄ to various soils.

FIG. 16 (panels a-b) shows the rates of mineralization/immobilization from two different rates of applying the NDRS in (a) Kern and (b) Monterey soil.

FIG. 17 shows an increase in corn yield (as measured in the silage and grain) in soil having OA-4 applied thereto (“Actagro” in the figure refers to the OA-4 treatment).

FIG. 18 shows increased soil ammonium levels (in ppm) in soil having OA-4 applied thereto (“Actagro” in the figure refers to the OA-4 treatment).

FIG. 19 shows increased soil nitrate levels (in ppm) in soil having OA-4 applied thereto (“Actagro” in the figure refers to the OA-4 treatment).

FIG. 20 shows increased nitrogen uptake within a crop (in pounds per acre).

FIG. 21 shows cumulative nitrogen mineralization as measured by NO₃⁻ concentration in leachate from three soils (a) Kern (b) Monterey (c) Tulare.

FIG. 22 shows the effect of OA-4 on potential surface runoff-phosphorus and nitrogen levels in surface soil (a) phosphorus (b) ammonium (c) nitrate.

### DETAILED DESCRIPTION

Definitions

It is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

List of Abbreviations
mg Milligrams
kg Kilograms
mL Milliliter
g Gram
μg Microgram
mm Millimeter
cm Centimeter
ac Acre
ha hectare
MPa Mega Pascal
NDRS Nutrient Depletion-Restricting Substance
wt Weight
L Liter
Lbs/Lb Pounds
mM Millimolar
Gal/gal Gallon
N Nitrogen
v volume
IPA Isopropanol
μL Microliter
M Molar
h hour
UAN Urea ammonium nitrate (UAN 28 contains 28% N by weight)

It must be noted that as used herein and in the appended claims, the singular forms “a”, “an”, and “the” include plural referents unless the context clearly dictates otherwise. Thus, for example, reference to “a nutrient” includes a plurality of nutrients.

Unless defined otherwise, all technical and scientific terms used herein have the same meaning as commonly understood by one of ordinary skill in the art to which this disclosure belongs. As used herein the following terms have the following meanings.

As used herein, the term “comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) claimed. “Consisting of” shall mean excluding more than trace elements of other ingredients and substantial method steps. Embodiments defined by each of these transition terms are within the scope of this disclosure.

The term “about” when used before a numerical designation, e.g., temperature, time, amount, and concentration, including range, indicates approximations which may vary by (+) or (−) 10%, 5% or 1%.

The term “fertilizer” is intended to refer to is any material of natural or synthetic origin (other than liming materials) that is applied to soils or to plant tissues (usually leaves) to supply one or more plant nutrients essential to the growth of plants. In certain embodiments, the fertilizer comprises one or more of a urea component, an ammonium component, a nitrate component, an ammonia component, an organic nitrogen component, and/or a phosphorus component.

The term “nutrient” is intended to refer to one or more macronutrient, such as nitrogen (N), phosphorus (P), potassium (K); calcium (Ca), magnesium (Mg), and/or sulfur (S).

The term “applying” or “applied” to the soil is intended to refer to any suitable method for applying a fertilizer and/or a NDRS to soil. The term is intended to encompass methods for applying liquid, solid, or other form or mixture thereof to the soil. In certain embodiments, the “applying” or “applied” to the soil comprises one or more of spraying, flooding, soil injection and/or chemigation.

The term “depletion rate” is intended to refer to the rate at which a fertilizer (or one or more nutrients) are depleted from the soil. In certain embodiments, the fertilizer is depleted at a rate of or less than about 50%, or less than about 40%, or less than about 30%, or about 20%, or less than about 10% as compared to fertilizer alone. In certain embodiments, the amount of nutrient (e.g., nitrogen) used to fertilize a crop may be reduced by at least about 25%, or at least about 40-50%. In certain instances, the nitrogen depleted from the soil is recovered in the biomass of the resultant crop grown therein. In certain embodiments, at least about 50 Lbs/acre of nitrogen may be recovered in the biomass of the resultant crop.

The term “reducing water and/or air pollution” is intended to refer to the reduction in one or more of nutrient loss by volatilization, leaching, and/or surface runoff In certain embodiments, the water and/or air pollution is reduced by at least about 50%, or at least about 40%, or at least about 30%, or at least about 20%, or at least about 10% as compared to fertilizer alone.

The term “nutrient availability” is intended to refer to the proportion of the total nutrient amount in soil can be taken up and utilized by plants. This fraction is called the available fraction, and depends on the chemical nature of the nutrient in question, as well as soil type and other influences from within the soil environment (see, e.g., Marscher, P. Mineral Nutrition of Higher Plants (Third Edition), 2012, Elsivier, Amsterdam).

Nutrient Depletion-Restricting Substances

The nutrient depletion-restricting substance (NDRS) includes a liquid formulation containing at least one, two and/or all three of the following components:

(1) plant material extracted from at least one of the group consisting of seaweed, algae and derivatives thereof;
(2) a plant growth stimulating composition produced as described in Marihart, U.S. Pat. Nos. 4,698,090 and/or 4,786,307 (the disclosures of which are incorporated herein by reference in their entirety);
(3) a humic extract from a genuine humic source, e.g., leonardite.

In some embodiments, the NDRS comprises a combination of Component 1 and Component 2, each at one to three parts by weight. In another embodiment, the NDRS comprises a combination of Component 2 and Component 3, at one part each by weight. In another embodiment, the NDRS comprises a combination of Component 1 at one to three parts by weight, Component 2 at one to three parts by weight and Component 3 at one to three parts by weight.

The humic extract (Component 3 above) can comprise any humic substance, including Component 2. For example, it can comprise one or more of a plant growth stimulating composition produced as described in Marihart (see, U.S. Pat. Nos. 4,698,090 and 4,786,307, the disclosures of which are incorporated herein by reference), or a humic substance (HS) comprising humic acid, fulvic acid and humin. Humic substances (HS) are defined by the IHSS (International Humic Substances Society) as complex, heterogeneous mixtures of polydispersed materials formed by biochemical and chemical reactions during the decay and transformation of plant and microbial remains (a process called humification). HS are naturally present in soil, water, peats, brown coals and shales. Traditionally these substances have been isolated into three fractions: humic acid, fulvic acid and humin. These fractions are operationally defined based on solubility in basic and acidic solutions. Leonardite, a brown coal, is known to be rich in humic acid.

In certain embodiments, the NDRS may optionally comprise one or more chelating agents (e.g., carbohydrates). The chelating agent can be any one or more of sodium, potassium, ammonium, copper, iron, magnesium, manganese, zinc, calcium, lithium, rubidium or cesium salt of ethylene diamine tetraacetic acid, hydroxyethylene diamine triacetic acid, diethylene triamine pentaacetic acid, nitrillo triacetic acid, or ethanol diglycine. In one embodiment, the chelating agent is a carbohydrate or a carboxylic acid, such as one selected from the group consisting of an ammonium or metal salt of a variety of organic acids. Non-limiting examples of organic acids, include citric acid, galactaric acid, gluconic acid, glucoheptoic acid, glucaric acid, glutaric acid, glutamic acid, tartaric acid, and tartronic acid.

A representative NDRS to be used in the methods provided herein can be prepared according to U.S. Pat. No. 4,698,090. For example, one exemplary NDRS can be prepared by adding 9 parts (by weight) of leonardite ore to 75 parts of water, previously heated to a temperature of 170° F. -195° F. but to no greater than 225° F. A carbohydrate or a carboxylic acid, such as one selected from the group consisting of an ammonium or metal salt of various organic acids (as described above), such as potassium tartrate (15 parts by weight), is added and the liquid composition is mixed for five hours and then allowed to settle in multiple stages. Depending upon the desired planting environment, the extracted liquid may be used in its resulting acidic condition. Alternatively, the pH may be adjusted by adding sodium hydroxide or potassium hydroxide.

In one embodiment, the NDRS can be prepared by adding 15-22 parts (by weight) of leonardite ore to 30-55 parts of water, previously heated to a temperature of 170° F. - 195° F. A carbohydrate or a carboxylic acid consisting of a metal salt such as potassium tartrate (9-16 parts by weight) is added. The liquid composition is oxygenated for a total of 15-300 minutes and a strong base at 5-12 parts is added, followed by the removal of some of the insoluble components of leonardite ore.

In one embodiment, an exemplary nutrient depletion-restricting substance (NDRS) comprises disaggregated humin (e.g., from about 2% to about 5%) in a colloidal suspension, as well as humic acid, fulvic acid, and optionally certain plant growth modification compositions and/or additional plant material extracts.

In certain embodiments, the composition may also comprise another source of nutrient, such a plant material extracted from at least one of the group consisting of seaweed, algae and derivatives thereof. In one embodiment, the composition also comprises seaweed.

In one embodiment, the NDRS is applied to the soil in combination with a fertilizer. The fertilizer may comprise any nitrogen and/or phosphorus containing fertilizer used for agricultural or other plant growth enhancing purposes. The fertilizer as used herein can comprise one or more of a urea component, an ammonium component, a nitrate component, an ammonia component, an organic nitrogen component, and/or a phosphorus component.

In certain embodiments, the fertilizer and the NDRS are pre-mixed in solution prior to the addition to the soil. Their respective concentrations may range from 1% to about 20%, or from 1% to about 15%, or from 1% to about 10% by weight NDRS to fertilizer. In certain embodiments, the weight/weight ratio of NDRS to fertilizer is about 1:100 to about 2:1. Exemplary ratios further include about 1:90, about 1:75; about 1:60; about 1:50; about 1:25; about 1:10; and about 1:1. .

Methods

In one aspect, the present disclosure involves treating the soil of an agricultural, turf or sod grass field or other planting site with a nitrogen and/or phosphorus based fertilizer in combination with a nutrient depletion-restricting substance as described herein. The soil to be treated can be any soil type, including, but not limited to, clay, loam, clay-loam, silt-loam, and the like. In some embodiments the soil comprises about 30-70% sand, about 20-60% silt, about 10-25% clay and about 0.5 to 3% organic matter. In some embodiment, the soil comprises about 20-40% sand, about 30-50% silt, about 20-40% clay and about 0.5 to 5% organic matter. In some embodiments, the soil comprises about 40% sand, about 45% silt, about 17% clay and about 3% organic matter or about 40% sand, about 45% silt, about 17% clay and about 3% organic matter or about 30% sand, about 40% silt, about 29% clay and about 1% organic matter, or about 65% sand, about 20% silt, about 14% clay and about 1% organic matter.

Conventional application techniques such as spraying, fertigation or shank injection may be employed. In certain embodiments, soil has been fertilized (i.e., fertilizer may have been pre-applied to the soil).

The amount of NDRS to be applied maybe calculated in a variety of ways. For example, the amount of NDRS may be expressed in a variety of units, including mass or volume of material per mass or volume of soil, area of land, or mass of fertilizer. In one embodiment, the rate may be the mass of NDRS per mass of fertilizer or mass of nitrogen or phosphorous in the fertilizer. Suitable rates include:

Units

| | Liters | Liter NDRS/100 |
|---|---|---|
| | NDRS/ha | kg N or P |
| Low end of range | 5 | 2 |
| | 20, 30, 50, 80, | 3, 8, 10, 12, |
| | 2000, or 5,000 | 30, 60, or 100 |
| High end of range | 15,000 | 150 |

In one embodiment, NDRS is applied in a range of from about 20 to about 50 Liters per hectare of soil. In one embodiment, the NDRS is applied in a range of from about 2 to about 12 Liters per 100 kilograms of nitrogen or phosphorous in the fertilizer.

The nutrient depletion-restricting substance (e.g., NDRS) as described herein is particularly preferable to known substances for restricting nutrient depletion because it affects the standard nitrogen cycle at multiple points, whereas each prior product is designed to act at a single point. The present method thereby eliminates the need to use multiple overlapping products, which are unduly expensive and tend to compound the adverse environmental effects commonly exhibited by each of those products.

Provided herein is a method for limiting the risk of nutrient contamination of the environment that has previously accompanied the use of agricultural fertilizers.

The methods described herein significantly control and reduce the depletion of the plant nutrients, such as nitrogen and phosphorus, present in the soil, by about 10% to greater than 50% and make this portion of those nutrients available for plant usage as the crop matures as compared to the use of a fertilizer alone. In certain embodiments, the present disclosure relates to a method for controlling the depletion rate of a nutrient in soil. The depletion rate can be a measure of nitrogen loss by any method, for example, volatilization and/or leaching. In one embodiment, the method comprises applying a NDRS and a fertilizer to soil or applying a NDRS to soil which has been fertilized, wherein the depletion of the nutrient was reduced by about 40 to about 80% by weight at about 30 hours after applying the NDRS and/or fertilizer to the soil. In other embodiments, the depletion of the nutrient was reduced by about 40%, or about 45%, or about 50%, or about 55%, or about 60% or about 65%, or about 70%, or about 75%, or about 80% by weight at about 24-36 hours after applying the NDRS and/or fertilizer to the soil.

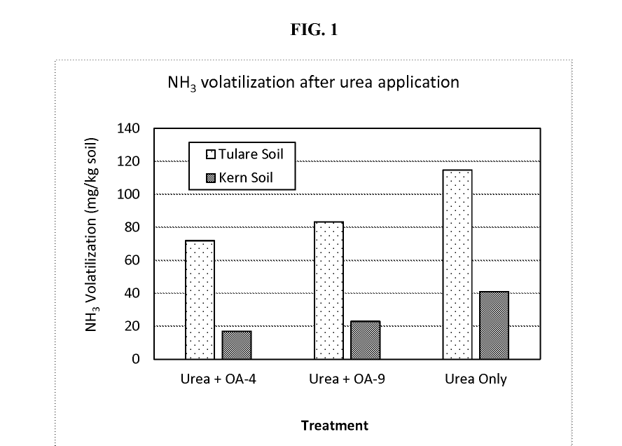

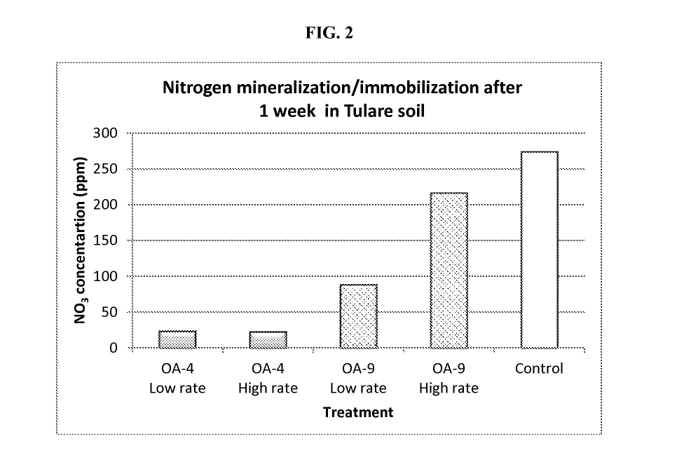

In particular, as shown in FIG. 1, the combination of fertilizer and NDRS in accordance with the present methods, significantly reduces ammonia (NH₃) volatilization following application of the fertilizer to the agricultural field. The NDRSs tested were found to have a significant mitigating influence on the rate ammonia is released to the atmosphere. As such, provided are methods for reducing water and/or air pollution caused by the use of a fertilizer in soil.

As depicted in FIG. 1, treatment with the mixture of urea and NDRSs OA-4 and OA-9 caused a significant reduction in the amount of ammonia released to the atmosphere. It is contemplated that this occurs because the NDRS provides for an increased adsorption surface for the ammonia. This reduces gas loss from the soil surface. It also delays nitrification of the urea from the fertilizer so that conversion to leachable nitrate occurs much closer to the time when the crop will require the nutrient. Rather than leaching through the soil and being wasted, the nitrogen is immobilized and stabilized until the plant grows sufficiently to require it as a nutrient.

In one embodiment, provided is a method for increasing nitrogen uptake within a crop, comprising applying a NDRS and optionally a fertilizer to soil or applying a NDRS to soil which has been fertilized. In certain embodiments, the weight of nitrogen contained in the biomass of the crop is increased by least about 15%, or about 50%, or about 45%, or about 40%, or about 35%, or about 30%, or about 25%, or about 20%, or about 15%, or about 10% by weight versus the weight of nitrogen contained in the biomass of a crop where a NDRS was not applied to the soil.

It is contemplated that the combined application of fertilizer and NDRS delays reaction of the nitrogen within the fertilizer with the urease enzymes in the soil. This in turn slows the conversion of urea by urease thereby reducing nitrogen losses due to urea volatilization. Instead, the nitrogen remains as urea able to be moved into the soil with rainfall or irrigation. When urea converts into ammonium in the root zone, nitrogen is adsorbed by the soil particles, stabilized and utilized effectively, as needed, by the growing plants. Subsurface nitrogen adsorption also minimizes accumulation of nitrates and ammonium in the surface soil, which can otherwise lead to denitrification and resultant volatilization of nitrogen gas or nitrous oxide from the soil or runoff with rainfall.

Accordingly, provided herein is a method of inhibiting nitrogen volatilization from soil, comprising applying a NDRS and a nitrogen-based fertilizer to the soil, wherein the amount of nitrogen loss via volatilization is reduced by at least about 40%, by at least about 45%, by at least about 50%, by at least about 55%, or up to about 60% by weight after about 7 days after applying the NDRS and/or nitrogen-based fertilizer. In certain embodiments, the temperature is from about 22 to about 35° C. In certain embodiments, the fertilizer is nitrogen based and comprises ammonia, ammonium, nitrate and/or urea. In certain embodiments, the NDRS is applied to the soil at a concentration of less than about 0.1 milligram of NDRS per 100 grams of soil, or less than about 0.5 milliliter of NDRS per 100 grams of soil, or less than about 0.1 milliliter of NDRS per 100 grams of soil.

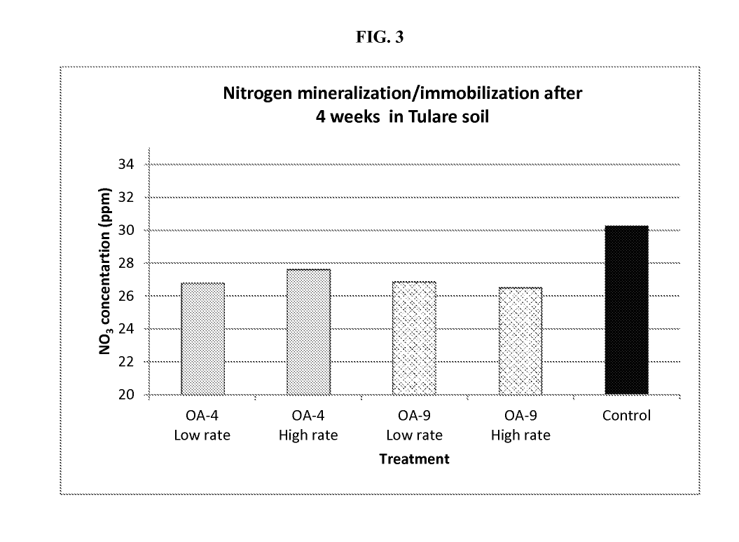

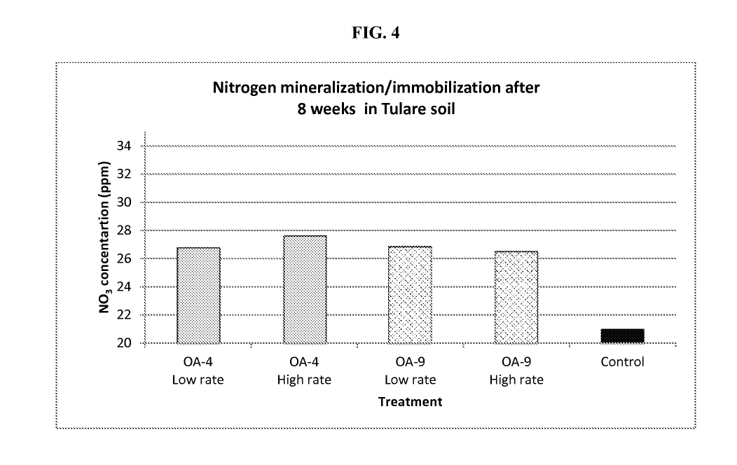

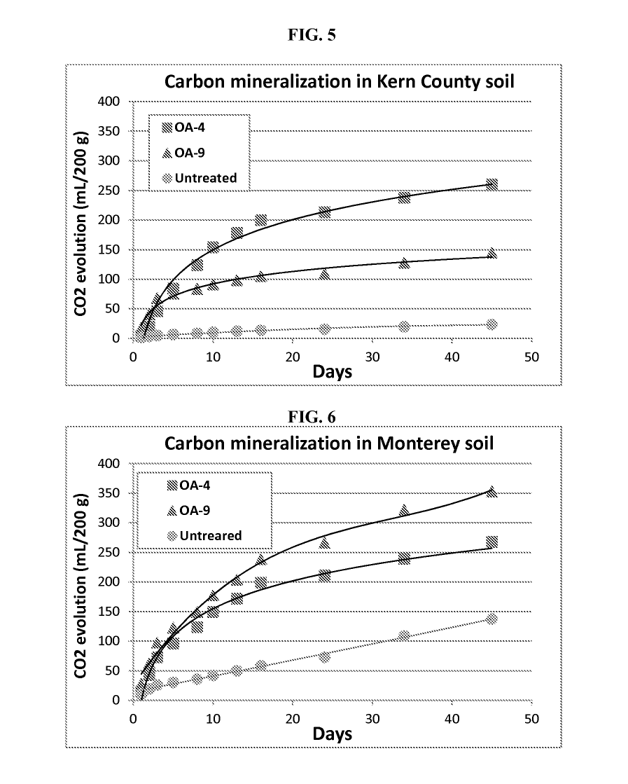

FIGS. 3 and 4 demonstrate that less nitrates leached out of the soil treated with the fertilizer and NDRS than leached from the untreated control (i.e., water alone). After 8 weeks, a significant residual amount of nitrate was present in the samples of soil treated with NDRS OA-4 and NDRS OA-9 (described below in the Examples) both at high and low rates (e.g., about 0.1 milliliter per 100 g of soil and about 1 milliliter per 100 g of soil, respectively). The amount of nitrates leaching from the control after 8 weeks was much less, thereby indicating that most of the nitrates already had leached from the control during the eight week interval. Far less had leached during the same period from the soil treated with NDRS accordance with this disclosure. Reduction in the rate of leaching yields a greater amount of residual nitrate within the soil, which is then available for use by the planted crops as needed. The application of mixtures in accordance with the present disclosure effectively immobilizes the nitrogen molecules resident in the soil to reduce the downward movement or leaching of the nitrogen in the soil solution. This method maintains more available nitrogen in the plant root zone and minimizes premature leaching and loss of the plant nutrients into the subsurface ground water.

It is believed that the beneficial reduction in leaching may occur due to, at least in part, the nutrient depletion-restricting substance chemically bonding to one or more of the two inorganic nitrogen molecules found in the soil and/or the three nitrogen molecules used in commercial granular and liquid fertilizers (urea, nitrates and ammonium) as well as the phosphorus molecules utilized in commercial granular and liquid fertilizers. This bond likely reduces leaching from recently applied fertilizer nitrates and urea in response to rainfall or irrigation. As a result, the runoff from the field caused by irrigation or rainfall is much less likely to contain levels of nitrogen or phosphorus which could contaminate or pollute nearby surface or subsurface bodies of water such as streams, rivers, lakes, aquifers, etc. In addition, nitrogen from the fertilizer is stabilized and resists moving with the soil water below the root zone when high volumes of rain fall or irrigation are encountered and the plant-supporting nitrogen remains in the root zone and provides needed nutrient to the growing plants.

In certain embodiments, provided herein is a method of decreasing nitrate leachate from soil by at least about 50% after about 3 weeks, comprising applying a NDRS to soil at a concentration of at least about 0.1 mg of NDRS per 100 grams of soil. In some embodiments, the nitrate leachate from soil is decreased by at least about 50% after about 100 days. Although it is contemplated that the present methods are effective in any soil type, in certain embodiments, the soil comprises about 40% sand, and may further comprise about 45% silt, about 17% clay and about 3% organic matter. In another embodiment, the soil comprises about 30% sand, and may further comprise about 40% silt, about 29% clay and about 1% organic matter.

In certain embodiments, the amount nitrate leached from the soil may be decreased by at least about 80%, or about 80%, or about 70%, or about 60%, when compared to soil which has not been treated with a NDRS as described herein. In some embodiments, the soil comprises about 65% sand, and may further comprise about 20% silt, about 14% clay and about 1% organic matter.

In another aspect, provided herein is a method for enhancing microbial activity as measured by the amount of CO₂ evolved from aerobic microbial respiration. The increased release of CO₂ indicates that as the microbial population increases, nitrogen is immobilized or stored in the microbial biomass to later provide nutrients to the developing crop. In effect, the increased production of carbon dioxide indicates that the microbial biomass is increasing and therefore requiring a greater amount of nitrogen than the control. The microbes' production of this carbon dioxide indicates that nitrogen is being effectively immobilized and stabilized in the root zone and not lost to leaching.

Use of fertilizer and a NDRS as described herein therefore effectively immobilizes nitrogen from nitrogen based granular and liquid fertilizers, crop residues, manures and manure slurries/wash water. This slows nitrification and denitrification and delays urease activity, which, in turn, minimizes rapid and/or large accumulation of nitrates in the soil. As the soil nitrate-N appears more slowly, this allows for crop demand to synchronize and increase proportionally with the increase of nitrogen availability. Microbial activity, as exhibited by

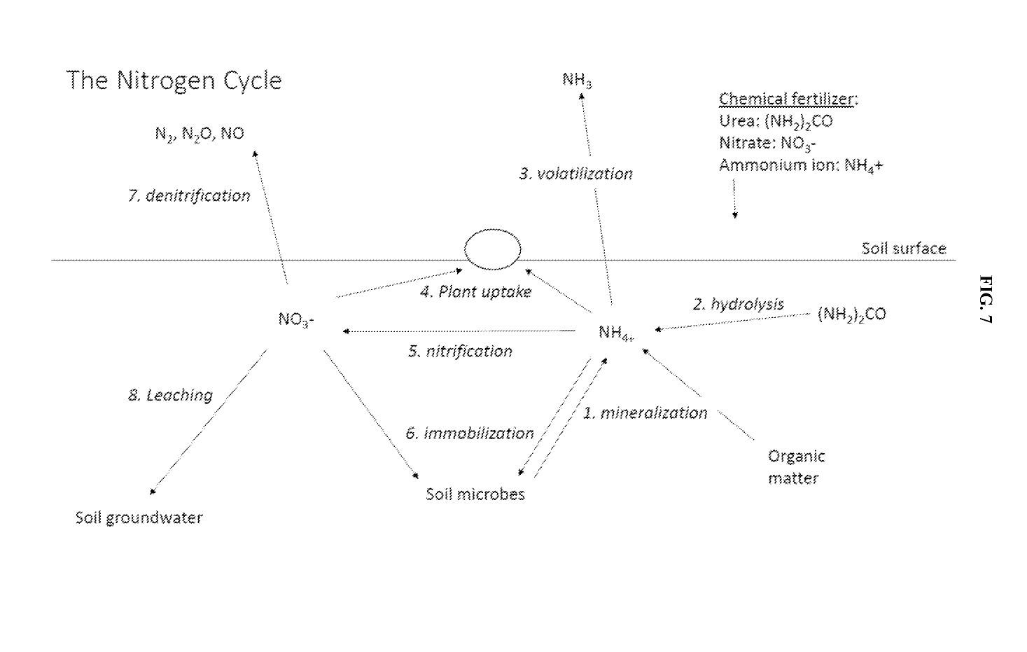

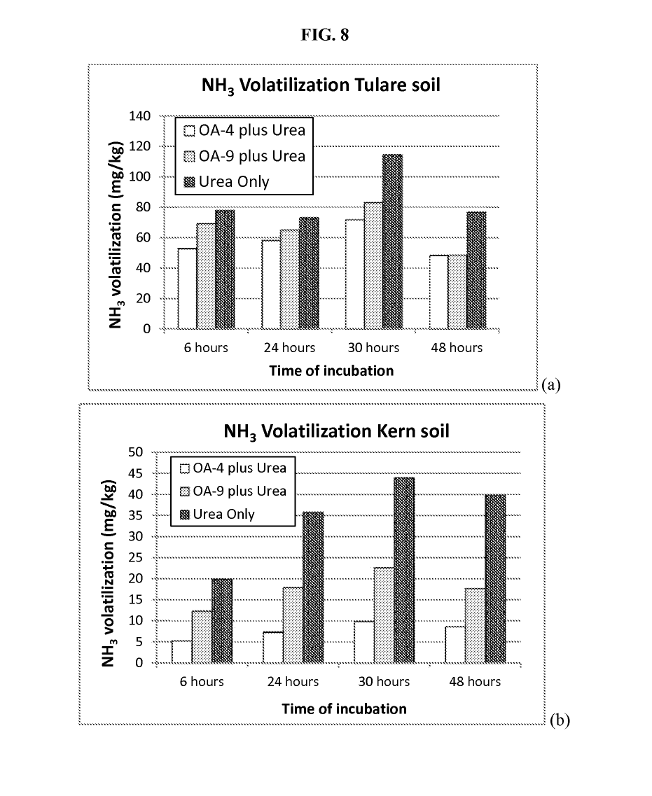

FIGS. 5 and 6, immobilizes nitrogen and with subsequent mineralization enables the fertilizer to work far more effectively and efficiently than in the past. Accordingly, in certain embodiments, the microbial activity is increased by at least about 10 fold after about 45 days in a soil having been treated with the NDRS versus the microbial activity in a soil in the absence of added NDRS. The NDRS may applied to the soil at a concentration of at least about 0.1 mg of NDRS per about 100 grams of soil, or between about 0.1 and 1 mg of NDRS per about 100 grams of soil.

Although the present methods may be used with any type of soil, in certain embodiments, the soil comprises about 65% sand, and may further comprise about 20% silt, about 14% clay and about 1% organic matter. In certain embodiments, the microbial activity is measured by evolution of carbon dioxide from the soil. Thus, in some embodiments, carbon dioxide evolution is increased by at least about 2 fold after about 45 days, and the soil comprises about 30% sand, and may further comprise about 40% silt, about 29% clay and about 1% organic matter.

In practice, organic residues may be added to the field following harvest. Decomposition of such residues and nitrogen release therefrom (mineralization) is seldom synchronized with crop growth. Use of the present method to treat such residues helps to promote nitrogen mineralization so that the nitrogen in the residue also becomes available as a plant nutrient at a time that beneficially coincides with the crop's need for nitrogen for optimum growth. This provides nitrate uptake before the nitrates overly accumulate in the soil and are more prone to leaching. Periodically adding the formulations of this disclosure to organic residues reduces depletion considerably compared to standard practices.

Provided herein is a method of increasing nitrate immobilization and/or mineralization in soil by at least about 25% after about 100 days, comprising applying a NDRS to soil. In certain embodiments, the NDRS is applied to the soil at a concentration of at least about 0.1 mg of NDRS per 100 grams of soil, or between about 0.1 mg and 1 gram of NDRS per about 100 grams of soil. In certain embodiments, the nitrate immobilization and/or mineralization is increased by at least about 50%, or at least about 45%, or at least about 40%, or at least about 35%, or at least about 30%, or at least about 25% after about 100 days. In certain embodiments, the immobilizing comprises inhibiting and/or mitigating transformation of nitrate (NO₃−) and/or ammonium (NH₄+) to nitrogen or ammonia gas.

As a further benefit, the NDRS to be used in the methods described herein are generally safer (e.g., to humans and the environment) and offer handling advantages over many other products which reduce nitrogen loss, some of which are labeled and licensed to be used as pesticides. In contrast, most existing chemicals used to prevent nutrient depletion pose risks to human health and the environment, depending on the exposure level.

Still further, the methods described herein reduce environmental hazards due to runoff. For example, phosphorous is lost in soil during erosion caused by rain. As shown in Example 9, by applying NDRS of the invention, it is contemplated that phosphorous runoff will be reduced.

Certain methods described herein are performed by applying a fertilizer and a NDRS concurrently or separately, at or about the same time (e.g., within about 3, or about 2, or about 1 hour of each other), to the soil of the agricultural field being treated. In certain embodiments of the methods described herein, the NDRS is applied to the soil with less than about three hours, or less than about two hours, or less than about one hour, or less than about 30 minutes, or less than about 20 minutes, or less than about 10 minutes, or less than about 5 minutes before or after applying the fertilizer. In certain embodiments, the fertilizer and the NDRS are pre-mixed and applied as a single composition. Application of the fertilizer and the NDRS within such a time window can avoid excessive nitrogen and phosphorus depletion and accomplish more effective and efficient nutrient delivery to the plantings.

In one embodiment, the NDRS and the fertilizer are pre-mixed in solution prior to the addition to the soil. Their respective concentrations may range from 1% to about 20%, or from 1% to about 15%, or from 1% to about 10% by weight NDRS to fertilizer. In certain embodiments, the weight/weight ratio of NDRS to fertilizer are from about 1:100 to about 2:1. Exemplary ratios further include about 1:90, about 1:75; about 1:60; about 1:50; about 1:25; about 1:10; and about 2:1.

The amount of NDRS applied to the soil may vary, and typically ranges from about 0.001 mL to about 100 mL of NDRS per kilogram of soil, or about 0.1 mL of NDRS per kilogram of soil, or about 0.03 mL per kilogram of soil, or about 0.05 mL per kilogram of soil, or about 1 mL of NDRS per kilogram of soil, or about 10 mL of NDRS per kilogram of soil, or about 20 mL of

NDRS per kilogram of soil, or about 30 mL of NDRS per kilogram of soil, or about 40 mL of NDRS per kilogram of soil, or about 50 mL of NDRS per kilogram of soil. In certain embodiments, the amount of NDRS applied to the soil ranges from about 0.001 mL to about 50 mL of NDRS per kilogram of soil.

### EXAMPLES

In each of the following Examples, the NDRS used are shown below.

OA-4 can be prepared by adding 14 parts (by weight) of dry leonardite ore to 52 parts of water, previously heated to a temperature of 185° F. A carbohydrate or a carboxylate metal salt such as potassium tartrate (16 parts by weight) is added and mixed for 2-3 hours. The liquid composition is oxygenated for 270 minutes and 10 parts of a strong base is added followed by the removal of the insoluble components of leonardite ore. The liquid composition is then isolated and pH adjusted with 1 part strong base. OA-4 can be considered either Component 2 or Component 3 (see description above under “Nutrient Depletion-Restricting Substances” and throughout this application).

OA-9 can be prepared by adding 1 to 3 part OA-4 plus 3 to 1 parts Suboneyo Seaweed. Suboneyo Seaweed is considered as Component 1 (see description above under “Nutrient Depletion-Restricting Substances” and throughout this application), and is commercially available from Suboneyo Chemicals Pharmaceuticals.

In each of the following Examples, the soils used are shown in the Table below.

| | | | | | % | |
|---|---|---|---|---|---|---|
| | | % | % | % | organic | |
| Name | Soil series name | Sand | Silt | Clay | matter | pH |
| Tulare | Colpien Loam | 39 | 44 | 17 | 3.1 | 7 |
| Kern | Exeter Sandy Loam | 66 | 21 | 13 | 0.58 | 6.2 |
| Fresno | Cerini Clay Loam | 29 | 41 | 30 | 0.37 | 7.9 |
| Monterey | Pacheco Clay | 31 | 41 | 28 | 1.1 | 7.4 |
| | Loam | | | | | |
| WISC | Milford Silty Clay | 20 | 40 | 40 | 4.1 | 6.6 |
| | Loam | | | | | |
| McCurdy | Tranquillity Clay | 9 | 32 | 60 | 1.6 | 7.8 |

### Example 1

### Effects of NDRS on Ammonia Volatilization from Agricultural Soils

The data shown in FIG. 1 was collected from soils in central California. Different soils (labeled Tulare (Loam) and Kern Soil (Sandy Loam)) which were treated to determine the influence of the NDRS in the presence of a fertilizer on ammonia volatilization. The NDRSs tested were found to have a significant mitigating influence on the rate ammonia is released to the atmosphere. Specifically, each treatment as described below was applied on the two soil samples. Each soil type was treated with urea both alone and in combination with each of two different compositions comprising a NDRS. The data shown in FIG. 1 indicates that the combination of fertilizer and a NDRS as described herein significantly reduces ammonia (NH₃) volatilization following application of the fertilizer to the agricultural field.

In one series of treatments, the NDRS labeled OA-4 was mixed in solution with urea at a concentration of 1 milliliter per 100 grams. In a second series of treatments, a second NDRS OA-9 was mixed in solution with urea also at a concentration of 1 milliliter per 100 grams. Finally, a urea and water only control solution was used. Each solution was added to each different types of soils sampled from the representative soils in California (respectively the Tulare soil and the Kern soil). Treatments were replicated three times. The solutions were then incubated for a week and ammonia volatilization was measured and averaged. As depicted in FIG. 1, treatment with the mixture of urea and NDRSs OA-4 and OA-9 caused a significant reduction in the amount of ammonia released to the atmosphere. It is contemplated that this occurs because the NDRS provides for an increased adsorption surface for the ammonia. This reduces gas loss from the soil surface. It also delays nitrification of the urea from the fertilizer so that conversion to leachable nitrate occurs much closer to the time when the crop will require the nutrient. Rather than leaching through the soil and being wasted, the nitrogen is effectively immobilized and stabilized until the plant grows sufficiently to require it as a nutrient.

It is further contemplated that the combined application of fertilizer and NDRS delays reaction of the nitrogen within the fertilizer with the urease enzymes in the soil. This in turn slows the conversion of urea by urease thereby reducing nitrogen losses due to urea volatilization. Instead, the nitrogen remains as urea able to be moved into the soil with rainfall or irrigation. When urea converts into ammonium in the root zone, nitrogen is adsorbed by the soil particles, stabilized and utilized effectively, as needed, by the growing plants. Subsurface nitrogen adsorption also minimizes accumulation of nitrates and ammonium in the surface soil, which can otherwise lead to denitrification and resultant volatilization of nitrogen gas or nitrous oxide from the soil or runoff with rainfall.

FIGS. 2-4 further illustrate how applying a NDRS alone reduces nutrient losses due to leaching of nitrates from the soil. As shown in FIGS. 2-4, five soil treatments were performed and measurements of nitrate concentration were tested at intervals of 1 week, 4 weeks and 8 weeks. In particular, four solution treatments were prepared as follows. The first treatment comprised NDRS OA-4 applied at a rate of 0.1 gram per 100 grams soil (low rate). A second solution comprised NDRS OA-4 and was applied at a rate of 1 gram per 100 grams soil (high rate). Two additional solutions were applied at the same rates but using NDRS OA-9. Finally, a fifth treatment of water alone was utilized as a control. Each treatment was added to each of three different types of soil sampled at three different locations. The soil samples were packed to 1.6 grams per cubic centimeter density in 15 centimeter tall clear black plastic columns and leached with one full volume of water weekly. The leachate was collected and analyzed for ammonium and nitrate. Treatments were replicated three times and the resultant averages at one, four and eight weeks are demonstrated in FIGS. 2, 3 and 4, respectively, for the loam soil from Tulare. Each solution featuring a formulation of the disclosure was measured after being applied at both the high rate and the low rate.

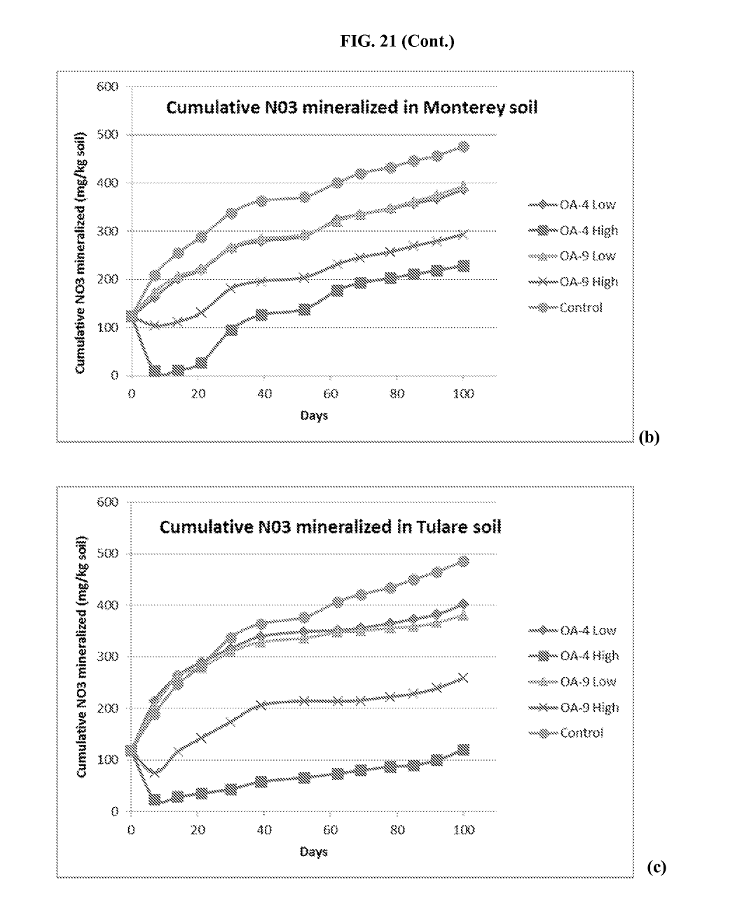

The results demonstrate that over the first four weeks of the experiment, a much smaller amount of nitrates leached out of the soil treated with the NDRS than leached from the untreated control. After 8 weeks, a significant residual amount of nitrate was present in the samples of soil treated with OA-4 and OA-9 both at high and low rates. The amount of nitrates leaching from the control after 8 weeks was much less, thereby indicating that most of the nitrates already had leached from the control during the eight week interval. Far less had leached during the same period from the soil treated with NDRS accordance with this disclosure. Reduction in the rate of leaching yields a greater amount of residual nitrate within the soil, which is then available for use by the planted crops as needed. The application of mixtures effectively immobilizes the nitrogen molecules resident in the soil to reduce the downward movement or leaching of the nitrogen in the soil solution. This maintains more available nitrogen in the plant root zone and minimizes premature leaching and loss of the plant nutrients into the subsurface ground water. When the cumulative amount of NO₃⁻ leached was calculated, it became clear that cumulative NO₃⁻ leached was significantly lower under the NDRS treatments, compared to the control (FIG. 21).

### Example 2

### Effects of NDRS on Microbial Growth and Nitrogen Immobilization in Agricultural Soils

FIGS. 5 and 6 show that microbial growth and attendant nitrogen immobilization can be achieved using the methods described herein. Two solutions containing NDRSs OA-4 and OA-9 were applied at a low rate (0.1 grams of NDRS per 100 grams of soil) and at a high rate (1.0 gram of NDRS per 100 grams of soil). The soil was then tested and compared to an unaltered water only control soil. Each solution was added to two different types of soil from Monterey and Kern County California locations. The treated soils were tested and compared to an untreated water only control soil. The soils were packed to 1.6 grams per cubic centimeter density in 15 cm tall clear plastic columns and kept moist by replacing moisture lost to evaporation weekly. The treatments were replicated three times. Soil columns were capped and CO₂ evolved from aerobic microbial respiration was measured weekly for eight weeks. The results depict a significant increase in CO₂ evolution for treatments using the combination as described herein.

The increased release of CO₂ indicates that as the microbial population increases, nitrogen is immobilized or stored in the microbial biomass to later provide nutrients to the developing crop. In effect, the increased production of carbon dioxide indicates that the microbial biomass is increasing and therefore requiring a greater amount of nitrogen than the control. The microbes' production of this carbon dioxide indicates that nitrogen is being effectively immobilized and stabilized in the root zone and not lost to leaching. Use of fertilizer and a NDRS as described herein therefore effectively immobilizes nitrogen from nitrogen based granular and liquid fertilizers, crop residues, manures and manure slurries/wash water. This slows nitrification and denitrification and delays urease activity, which, in turn, minimizes rapid and/or large accumulation of nitrates in the soil. As the nitrates in the soil slowly accumulate, this allows for crop demand to synchronize and increase proportionally with the increase of nitrogen availability. Microbial activity, as exhibited by FIGS. 5 and 6, immobilizes nitrogen and with subsequent mineralization enables the fertilizer to work far more effectively and efficiently than in the past.

### Example 3

### Effects of NDRS on Nitrogen Mineralization/Immobilization Dynamics in Agricultural Soils

The objective of this study was to compare NH₃ volatilization following broadcast a mixture of urea plus exemplary NDRS (5:1 ratio) to three different soil types. NH₃ above the soil in a closed system was measured five times over 48 hours. Cumulative NH₃ losses from urea were reduced by >50% when urea is applied with exemplary NDRS to soils with low clay content and neutral pH. Volatilization was the least in the soil that had high clay content and high pH. Urease enzyme is a basic molecule and is more stable at high pH or when clay content is high. However, the hydrolysis of urea occurred very rapidly in all soils as indicated by enhanced NH₃ flux between 6 and 30 hours after application of urea or urea-humic NDRS mixture.

### Materials and Methods:

Soils: 100 g in each jar. Tulare County, Kern County, and Monterey County.

Treatment 1: OA-4 plus urea.

Treatment 2: OA-9 plus urea.

Treatment 3: Urea only.

OA-4 and OA-9 each contained about 10-11% total carbon (weight/weight) with a pH in of about 11 to about 13. OA-4 and OA-9 contained a negligible amount of nitrogen (<1% by weight).

In a 500 mL volumetric flask, 125 g urea was dissolved and 25 mL of OA-4 or OA-9 was added and dissolved. The mixture was brought to the 500 mL mark and mixed well. This mixture contained 250 mg/mL urea and 50 mg/mL OA-4 or OA-9 (assuming a density of 1 g/mL). In Treatment 1 and Treatment 2, 25 mL of the Urea-OA mixture was added into a jar containing 100 g soil. The 25 mL mixture contained 6,250 mg urea and 1,250 mg OA-4 (in the case of Treatment 1) or OA-9 (in the case of Treatment 2). The concentrations in soil were 62,500 mg urea/kg soil and 12,500 mg OA-4 or OA-9/kg soil. Urea control received 25 mL of 250,000 μg/mL of urea solution alone. Each soil treatment has duplicates and untreated controls. Ammonia was measured after 6, 24, 30, and 48 hours where gas evolving from the soil is passed through an acid trap (0.05 M H₃PO₄) and measured by gas chromatography (see, e.g., Rochette, P. et al. Soil & Tillage Research, 2009, 103: 310-315). Volatilization rate (flux) was calculated from the 6 and 30 hours measurements (24 hours flux).

List of treatments:

| | Soil | Ratio 1:5 | |
|---|---|---|---|
| Sample # | (100 g/jar) | Fertilizer/Urea | |
| 1 | Tulare | OA-4 + Urea | Rep 1 |
| 2 | Tulare | OA-4 + Urea | Rep 2 |
| 3 | Tulare | OA-9 + Urea | Rep 1 |
| 4 | Tulare | OA-9 + Urea | Rep 2 |
| 5 | Kern | OA-4 + Urea | Rep 1 |
| 6 | Kern | OA-4 + Urea | Rep 2 |
| 7 | Kern | OA-9 + Urea | Rep 1 |
| 8 | Kern | OA-9 + Urea | Rep 2 |
| 9 | Monterey | OA-4 + Urea | Rep 1 |
| 10 | Monterey | OA-4 + Urea | Rep 2 |
| 11 | Monterey | OA-9 + Urea | Rep 1 |
| 12 | Monterey | OA-9 + Urea | Rep 2 |
| 13 | Tulare | Urea Only | |
| 14 | Kern | Urea Only | |
| 15 | Monterey | Urea Only | |
| 16 | Tulare | Urea Only | |
| 17 | Kern | Urea Only | |
| 18 | Monterey | Urea Only | |

### Results and Discussion

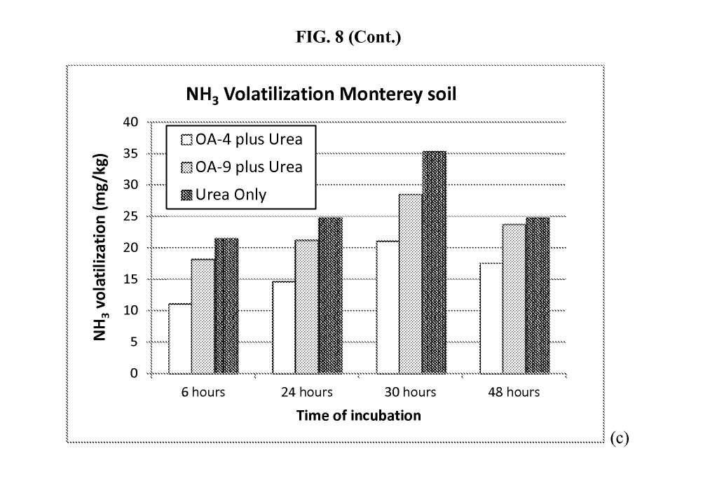

FIG. 8 shows the ammonia volatilization released from the soil when treated with urea with and without OA-4 and OA-9. A number of general trends were observed:
The release of NH₃ peaked at about 30 hours after urea treatment. This was similar to the timing of peak volatilization after urea application reported in the literature.
The reduction of NH₃ by the two NDRSs was clearly observed in all three soil types.
OA-4 had a more pronounced effect on reduction of NH₃ compared to OA-9.
The magnitude of the reduction associated with OA-4 at 30 hours was quite large, 37% to 77% reduction in NH₃ loss, compared to the urea treatment alone.
The soil with the most significant reduction associated with OA-4 (Kern, 77% reduction) had a relatively low volatilization rate in the urea-only treatment (about 44 mg/ kg soil).

Several potential reasons for the reduction of NH₃ volatilization by the NDRS OA-4 and OA-9 are contemplated. For example,

1. The substances may interact with/adsorb to urea, slowing its conversion into ammonium carbonate and then NH₄⁺;

2. The substances may inhibit the urease enzyme;

3. The substances may provide for an increased adsorption surface for the ammonia (which reduces gas loss from the soil surface);

4. The substances may adsorb to NH₄⁺, slowing or preventing its conversion to NH₃;

5. The substances may stimulate plant growth, which in turn increases uptake of NH₄⁺, decreasing its conversion into NH₃; and/or

6. Some combination of the above.

### Conclusions/Summary

The results of this study support the conclusion that the NDRS reduce the size of the soil NO₃⁻ pool compared to that found in the native soil without the applied materials. That is, these materials act as a nitrogen stabilizer. It is contemplated that this is due to one or more of the following mechanisms:
The NDRSs have a priming effect on the soil microbial pool, which in turn immobilizes soil N in the forms of NO₃⁻ and NH₄ ⁺;
The NDRSs interact with NH₄⁺, slowing its transformation to NO₃;
The NDRSs act as a nitrification inhibitor;
The NDRSs reduce the potential for NO₃⁻ leaching, based on the reduced pool of nitrate found; and/or
The NDRSs form complexes with, and or adsorb to, NO₃⁻ to slow its leaching loss in the soil profile.

### Example 4

### Effects of NDRSs on Nitrogen Mineralization/Immobilization Dynamics in Agricultural Soils

### Materials and Methods

Surface soils from Tulare County (Soil 1), Kern County (Soil 2), and Monterey County, California (Soil 3) were collected from cultivated agricultural land. These soils were chosen because they represent typical soils used for crop production. The soils were collected, passed is through a 2 mm screen and homogenized. Before starting the incubation experiments, samples were preconditioned with water and incubated at 25° C. for 1 week.

Soils treatments consisted of an untreated control and two rates each of OA-4 and OA-9. The rates were 0.25 mL and 5 mL of liquid per 100 g soil. Each treatment was replicated three times. The treatment list is shown in Table 1.

TABLE 1

| Sample | Soil | NDRS | Rate | Rep |
|---|---|---|---|---|
| 101 | Tulare | OA-4 | Rate 2 | Rep 1 |
| 102 | Tulare | OA-4 | Rate 2 | Rep 2 |
| 103 | Tulare | OA-4 | Rate 2 | Rep 3 |
| 104 | Tulare | OA-4 | Rate 1 | Rep 1 |
| 105 | Tulare | OA-4 | Rate 1 | Rep 2 |
| 106 | Tulare | OA-4 | Rate 1 | Rep 3 |
| 107 | Tulare | OA-9 | Rate 2 | Rep 1 |
| 108 | Tulare | OA-9 | Rate 2 | Rep 2 |
| 109 | Tulare | OA-9 | Rate 2 | Rep 3 |
| 110 | Tulare | OA-9 | Rate 1 | Rep 1 |
| 111 | Tulare | OA-9 | Rate 1 | Rep 2 |
| 112 | Tulare | OA-9 | Rate 1 | Rep 3 |
| 113 | Kern | OA-4 | Rate 2 | Rep 1 |
| 114 | Kern | OA-4 | Rate 2 | Rep 2 |
| 115 | Kern | OA-4 | Rate 2 | Rep 3 |
| 116 | Kern | OA-4 | Rate 1 | Rep 1 |
| 117 | Kern | OA-4 | Rate 1 | Rep 2 |
| 118 | Kern | OA-4 | Rate 1 | Rep 3 |
| 119 | Kern | OA-9 | Rate 2 | Rep 1 |
| 120 | Kern | OA-9 | Rate 2 | Rep 2 |
| 121 | Kern | OA-9 | Rate 2 | Rep 3 |
| 122 | Kern | OA-9 | Rate 1 | Rep 1 |
| 123 | Kern | OA-9 | Rate 1 | Rep 2 |
| 124 | Kern | OA-9 | Rate 1 | Rep 3 |
| 125 | Monterey | OA-4 | Rate 2 | Rep 1 |
| 126 | Monterey | OA-4 | Rate 2 | Rep 2 |
| 127 | Monterey | OA-4 | Rate 2 | Rep 3 |
| 128 | Monterey | OA-4 | Rate 1 | Rep 1 |
| 129 | Monterey | OA-4 | Rate 1 | Rep 2 |
| 130 | Monterey | OA-4 | Rate 1 | Rep 3 |
| 131 | Monterey | OA-9 | Rate 2 | Rep 1 |
| 132 | Monterey | OA-9 | Rate 2 | Rep 2 |
| 133 | Monterey | OA-9 | Rate 2 | Rep 3 |
| 134 | Monterey | OA-9 | Rate 1 | Rep 1 |
| 135 | Monterey | OA-9 | Rate 1 | Rep 2 |
| 136 | Monterey | OA-9 | Rate 1 | Rep 3 |
| 137 | Tulare | Rep 1 | Control | |
| 138 | Tulare | Rep 2 | Control | |
| 139 | Tulare | Rep 3 | Control | |
| 140 | Kern | Rep 1 | Control | |
| 141 | Kern | Rep 2 | Control | |
| 142 | Kern | Rep 3 | Control | |
| 143 | Monterey | Rep 1 | Control | |
| 144 | Monterey | Rep 2 | Control | |
| 145 | Monterey | Rep 3 | Control | |

No other potential nitrogen source was applied to the soil during the study. The method used for determining nitrogen mineralization was similar to those described by Ajwa et al. (Ajwa, H. A. et al. Soil Sci. Soc. Am. J., 1998, 62:942-951). For leaching of the mineralized inorganic nitrogen (NH₄⁺ and NO₃⁻), 100 g of soil was packed into a leaching cup to a bulk density of =1.4 g cm⁻³. To avoid crusting of the soil surface and to prevent displacement of the soil, 2 g of fine HCl-washed Ottawa sand were added on top of the soil and a thin glass wool pad was placed over the surface.

At approximately weekly intervals from initial treatment until 100 days later, the core was leached with 100 mL of 0.01 M CaCl₂ solution in increments of 20 mL. The leachate recovered in the bottle below and was brought up to 100 mL with 0.01 M CaCl₂ solution. After leaching, 20 mL of a nitrogen-free nutrient solution were added to the cores to replenish nutrients lost by leaching. The nitrogen-free nutrient solution was prepared with KH₂PO₄, K₂SO₄, MgSO₄, and CaSO₄ to contain 100, 24, 113, 0.5, and 4 mg/L of Ca, Mg, S, P, and K, respectively. The core then was drained for 6 h with a vacuum pump to obtain a uniform soil water potential of 0.033 MPa. The leachate was analyzed for NO₃⁻. Between leachings, the samples were incubated at 25° C. Untreated controls did not receive experimental treatments, but were leached exactly like the treated soils.

Expected cumulative NO₃⁻ concentration over time in soil was calculated by adding the initial NO₃⁻ concentration to each successive measurement, for each treatment and soil type. Furthermore, the effect of OA-4 or OA-9 on net mineralization/immobilization was measured as the difference between two rates, expressed in mg NO₃− per kg soil per unit time, as follows:

Rₜ=Sₜ−Nₜ (Equation 1),

where Sₜ is the rate of mineralization/immobilization during time interval t associated with the humate treatment, while Nₜ is the native rate (control without humate treatment) of mineralization/immobilization during the same time interval. Where Sₜ or Nₜ is negative, immobilization is indicated. Where Sₜ or Nₜ is positive, mineralization is indicated.

When Rₜ was positive, it indicated that the treatment effect was to increase mineralization vs. the native rate. When Rₜ was negative, it indicated that the treatment effect was to increase net immobilization vs. the native rate. Thus, the magnitude of Rₜ indicates the magnitude of the treatment effect. Further, the magnitude of the change can be expressed as a percentage of the native rate, as follows:

%Effect=(Rₜ*100)/Nₜ (Equation 2)

This parameter compares the slope of the curve of the various treatments to the slope of the control curve for each soil and duration tested. This parameter was calculated for the first 21 days of the experiment across 7 day intervals. Each treatment was replicated three times.

### Results and Discussion

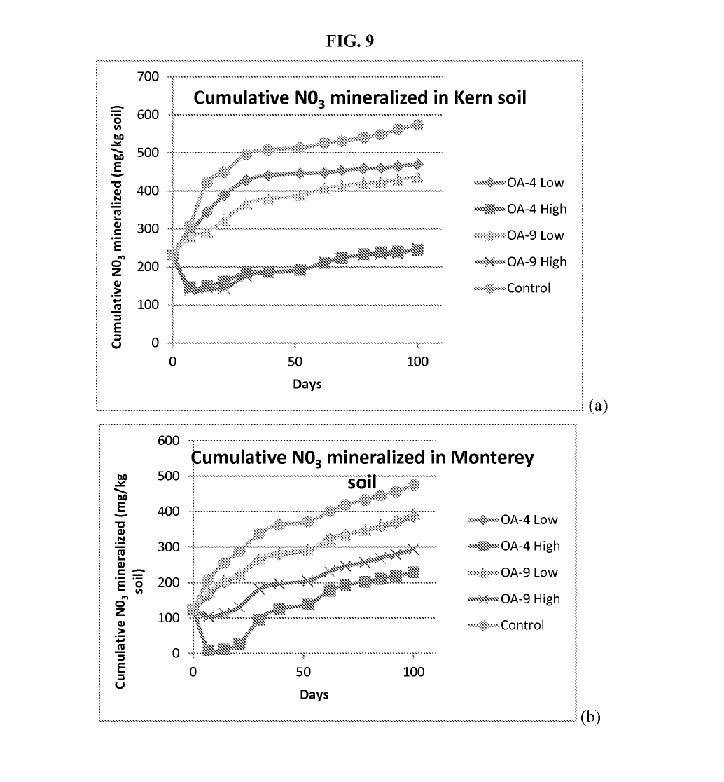

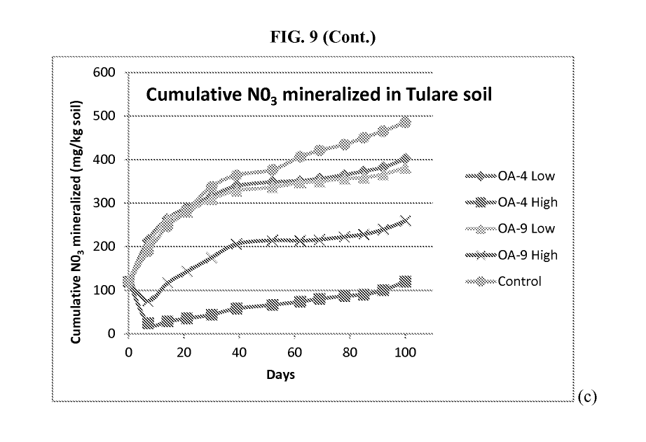

FIGS. 9a-c show results of mineralization as measured by NO₃⁻ concentration in the three test soils. For all treatment/soil combinations, the pool of nitrate measured in soil over time was never greater, and was typically significantly lower, than the native NO₃− pool measured in the untreated soil. FIG. 21 shows cumulative data. This data supports one or more of the following:

1. The NDRSs have a priming effect on the soil microbial pool, which in turn immobilizes soil N in the forms of NO₃− and NH₄+;

2. The NDRSs interact with NH₄+, slowing its transformation to NO₃−;

3. The NDRSs act as a nitrification inhibitor;

4. The NDRSs reduce the potential for NO₃− leaching, based on the reduced pool of nitrate found;

5. The NDRSs form complexes with, and or adsorbs to, NO₃− to slow its leaching loss in the soil profile; and/or

6. Some combination of the above.

For the sake of simplicity, in the remaining discussion, the term “mineralization” is used to describe the phenomena associated with increasing soil NO₃− pools, while “immobilization” is used to describe decreased NO₃− pools.

The effect seemed to be more pronounced in soils containing low soil organic matter (Monterey and Kern soils), but was less pronounced, although still present in soils that contained high (>4%) soil organic matter (Tulare). This suggests that number 1, above, may be the most plausible explanation of the results observed. The NDRSs contain both labile and refractory carbon chains, both of which could have a beneficial effect on soil microorganisms.

### Comparison of NDRSs in Their Ability to Reduce the NO₃− Pool.

Across the three soils, the effect of the rate of the NDRS was much larger than the difference between the NDRSs. However, some differences among the NDRSs were observed (FIG. 9):
In the Kern soil only, the low rate of OA-9 was associated with a lower soil NO₃− pool than was OA-4;
In the Monterey and Tulare soils only, the high rate of OA-4 was associated with lower soil NO₃− pools than was OA-9; and
n all other soil/rate combinations, the two NDRSs were similar in their effect on soil NO₃− pools.

### Rates of Mineralization/Immobilization

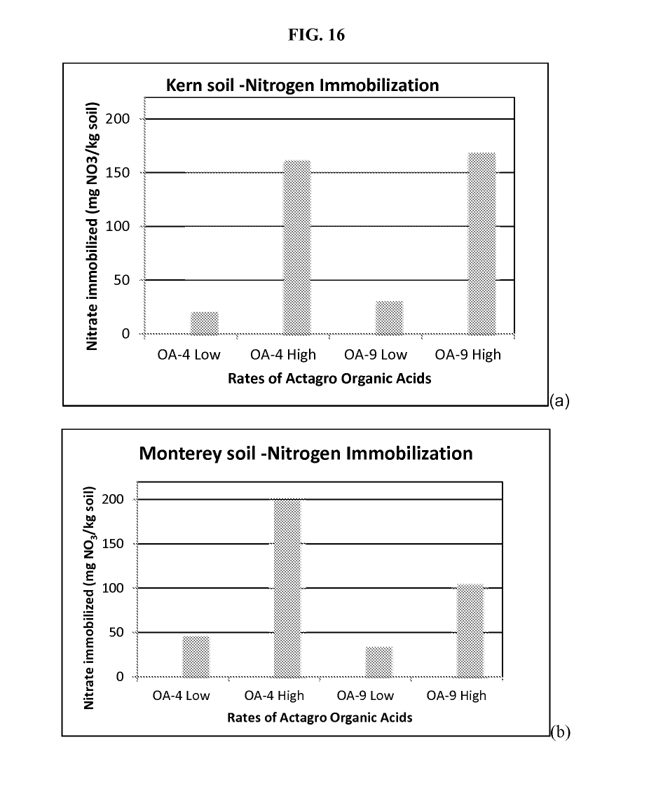

FIG. 16 shows the rates of mineralization/immobilization from the two rates of the two NDRSs in the Kern and Monterey soils.

Magnitude of the %Effect of NDRSs (from Equation 2)

The data for the two NDRSs was pooled to observe the net %Effect. Tables 2 and 3 show the effect of application rate on the apparent rate of immobilization/mineralization, expressed as a percentage of the native rate (Equation 2). Table 2 shows the %Effect of low rate of treatment on apparent mineralization/immobilization as measured by NO₃− leachate in three soil types. The calculation method is shown in Equation 2. The numbers in the table are the means of the two treatments, the effects of which were similar.

TABLE 2

| Interval | Kern | Monterey | Tulare |
|---|---|---|---|
| 0-7 days | −34% | −47% | 27% |
| 7-14 days | −69% | −24% | −5% |
| 14-21 days | 67% | −48% | −40% |

Table 3 shows the effect of high rate of treatment on apparent mineralization/immobilization as measured by NO₃− leachate. The calculation method is shown in Equation 2. The numbers in the table are the means of the two treatments, the effects of which were similar.

TABLE 3

| Interval | Kern | Monterey | Tulare |
|---|---|---|---|
| 0-7 days | −215% | −177% | −198% |
| 7-14 days | −97% | −90% | −60% |
| 14-21 days | −83% | −48% | −53% |

From Tables 2 and 3, it can be seen from the tables that in almost all soil type over time, the % Effect was negative, which means that NDRS treatment was strongly associated with net immobilization vs. the native rate. Only two cases (Table 2) showed a positive percent effect, associated with increased mineralization. In addition, the magnitude of the effect was stronger with the higher rate of NDRS.

### Conclusions

The results of this study support the conclusion that the NDRS reduces the size of the soil NO₃− pool compared to that found in the native soil without the applied materials. In other words, these materials act as a nitrogen stabilizer, which is likely due to one or more of the following mechanisms:
The NDRSs have a priming effect on the soil microbial pool, which in turn immobilizes soil N in the forms of NO₃− and NH₄+. This is believed to be the most plausible/strongest mechanism at work in this system;
The NDRSs interact with soil NH₄+, slowing its transformation to NO₃−;
The NDRSs act as a nitrification inhibitor;
The NDRSs reduce the potential for NO₃-leaching, based on the reduced pool of nitrate found; and/or
The NDRSs form complexes with, and or adsorbs to, NO₃− to slow its leaching loss in the soil profile.

### Example 5

### Effects of NDRSs on Carbon Mineralization and Stimulation of Soil Microbes in Agricultural Soils

This study shows that the NDRS stimulates soil microorganisms which release CO₂ during their growth and maintenance respiration. In at least one case, there was a clear “priming effect” of the NDRS, where the soil microbes were stimulated to consume carbon from native soil organic matter, which they did not consume in the absence of NDRS.

Microbial activity was significantly stimulated by both NDRSs, at both low and high rates. Such microbial activity may have a positive impact on immobilization of mineral nitrogen, which in turn would reduce the potential for leaching in soils treated with NDRSs.

### Materials and Methods

Surface soils from Tulare County (Soil 1), Kern County (Soil 2), and Monterey County, Calif. (Soil 3) were collected from cultivated agricultural land. These soils were chosen because they represent typical soils used for crop production. The soils were collected, passed through a 2 mm screen and homogenized. Before starting the incubation experiments, samples were preconditioned with water and incubated at 25° C. for 1 week.

Soils treatments consisted of untreated control and two rates of OA-4 and OA-9 (see Example 1). The rates were 0.5 mL and 10 mL of product per 200 g soil. Untreated controls did not receive organic acids. Each treatment was repeated 3 times.

The method used for determining nitrogen mineralization was similar to those described by Ajwa et al. (Ajwa, H. A. et al. Biol. Fertil. Soils, 1994, 18:175-182). A 200 g soil sample was placed in 500 mL jar and the NDRS solution (0.5 mL or 10 mL) was applied to the soil. The jar was then sealed with a cap that has a rubber septum for gas sampling.

The CO₂ evolved from the soil was determined for 45 days by taking a gas sample from the headspace in the Mason jar through the rubber septum. The concentration of CO₂ was determined with an Agilent 3000A micro gas chromatograph equipped with a Porapak Q column at 60° C. and a thermal conductivity detector at 70° C. After the CO₂ was measured, the jar was opened and allowed to equilibrate with the atmosphere. Between measurements, the jars were incubated at 25° C. The treatments are shown in Table 4.

TABLE 4

| | | | Rate (Organic | | |
|---|---|---|---|---|---|
| Sample # | Soil | NDRS | acid/200 g soil) | | Rep # |
| 1 | Tulare | OA-4 | 0.5 | ml | Rep 1 |
| 2 | Tulare | OA-4 | 0.5 | ml | Rep 2 |
| 3 | Tulare | OA-4 | 0.5 | ml | Rep 3 |
| 4 | Tulare | OA-4 | 10 | ml | Rep 1 |
| 5 | Tulare | OA-4 | 10 | ml | Rep 2 |
| 6 | Tulare | OA-4 | 10 | ml | Rep 3 |
| 7 | Tulare | OA-9 | 0.5 | ml | Rep 1 |
| 8 | Tulare | OA-9 | 0.5 | ml | Rep 2 |
| 9 | Tulare | OA-9 | 0.5 | ml | Rep 3 |
| 10 | Tulare | OA-9 | 10 | ml | Rep 1 |
| 11 | Tulare | OA-9 | 10 | ml | Rep 2 |
| 12 | Tulare | OA-9 | 10 | ml | Rep 3 |
| 13 | Kern | OA-4 | 0.5 | ml | Rep 1 |
| 14 | Kern | OA-4 | 0.5 | ml | Rep 2 |
| 15 | Kern | OA-4 | 0.5 | ml | Rep 3 |
| 16 | Kern | OA-4 | 10 | ml | Rep 1 |
| 17 | Kern | OA-4 | 10 | ml | Rep 2 |
| 18 | Kern | OA-4 | 10 | ml | Rep 3 |
| 19 | Kern | OA-9 | 0.5 | ml | Rep 1 |
| 20 | Kern | OA-9 | 0.5 | ml | Rep 2 |
| 21 | Kern | OA-9 | 0.5 | ml | Rep 3 |
| 22 | Kern | OA-9 | 10 | ml | Rep 1 |
| 23 | Kern | OA-9 | 10 | ml | Rep 2 |
| 24 | Kern | OA-9 | 10 | ml | Rep 3 |
| 25 | Monterey | OA-4 | 0.5 | ml | Rep 1 |
| 26 | Monterey | OA-4 | 0.5 | ml | Rep 2 |
| 27 | Monterey | OA-4 | 0.5 | ml | Rep 3 |
| 28 | Monterey | OA-4 | 10 | ml | Rep 1 |
| 29 | Monterey | OA-4 | 10 | ml | Rep 2 |
| 30 | Monterey | OA-4 | 10 | ml | Rep 3 |
| 31 | Monterey | OA-9 | 0.5 | ml | Rep 1 |
| 32 | Monterey | OA-9 | 0.5 | ml | Rep 2 |
| 33 | Monterey | OA-9 | 0.5 | ml | Rep 3 |
| 34 | Monterey | OA-9 | 10 | ml | Rep 1 |
| 35 | Monterey | OA-9 | 10 | ml | Rep 2 |
| 36 | Monterey | OA-9 | 10 | ml | Rep 3 |
| 37 | Tulare | Control | | | Rep 1 |
| 38 | Tulare | Control | | | Rep 2 |
| 39 | Tulare | Control | | | Rep 3 |
| 40 | Kern | Control | | | Rep 1 |
| 41 | Kern | Control | | | Rep 2 |
| 42 | Kern | Control | | | Rep 3 |
| 43 | Monterey | Control | | | Rep 1 |
| 44 | Monterey | Control | | | Rep 2 |
| 45 | Monterey | Control | | | Rep 3 |

### Results and Discussion

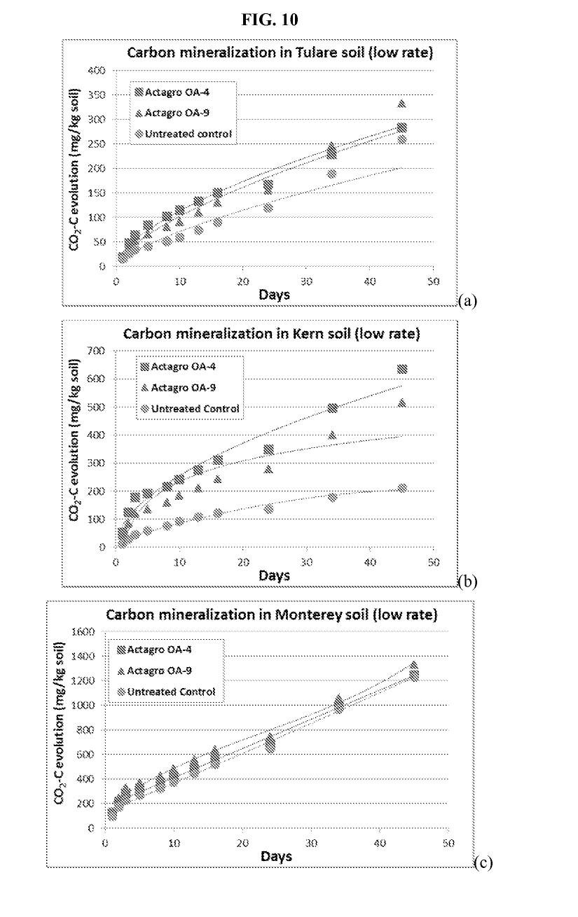

FIG. 10 illustrates CO₂ evolution caused by microbial growth when NDRSs at the low rate were applied to the soil. Several observations can be made about these data. First, in two of the soils (Kern and Tulare) there was an observable increase in CO₂ evolution associated with NDRS. Second, in both cases, OA-4 was associated with more CO₂ release than OA-9. Third, in the Monterey soil, where CO₂ evolution was high with or without NDRS (>1200 mg/kg soil at 45 days), the NDRS effect was minimal.

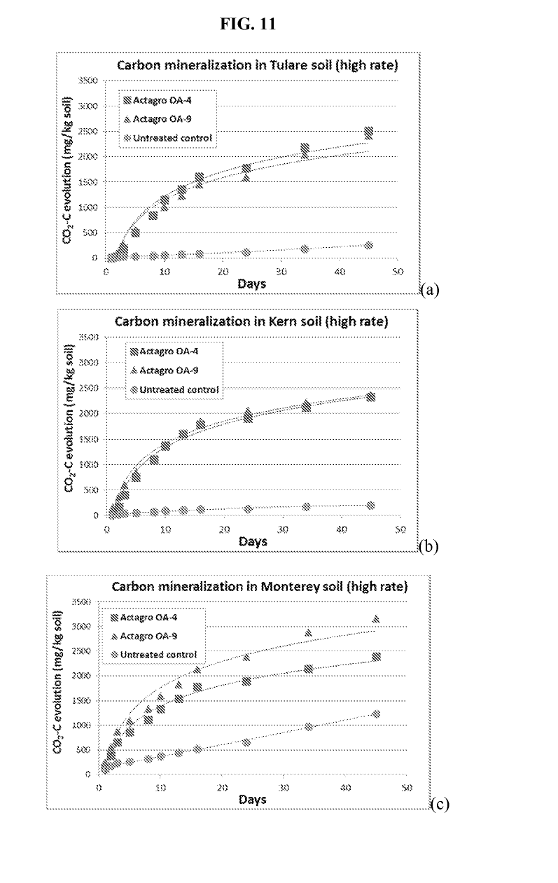

FIG. 11 illustrates CO₂ evolution caused by microbial growth when NDRSOA-4 and OA-9 at the high rate were applied to the soil. The following observations can be made about the data shown in FIG. 11:
In all three soils, there was a very large increase in CO₂ evolution associated with NDRS treatment;
In one soil (Monterey), OA-4 was associated with more CO₂ release than OA-9;
In the other two soils, the two materials were similar with respect to CO₂ evolution; and
In the Monterey soil, where CO₂ evolution was the highest without NDRS treatment (>1.2 g/kg soil at 45 days), NDRS treatment still was associated with a large increase in CO₂ output.

### Stimulation of Soil Microbes by NDRSs—“Priming Effect”

The following study was performed to show if the carbon in the CO₂ evolved in this experiment is coming directly from carbon in the NDRSs, from the native carbon in soil organic matter, or a combination thereof. Accordingly, the mass of the carbon being evolved as CO₂ was considered. Table 5 shows the carbon additions from OA-4 in this example.

TABLE 5

| Variable | | Units |
|---|---|---|
| Soil per cup | 200 | g soil |
| Carbon addition | | |
| Low rate | 0.5 | mL OA-4 per cup |
| High rate | 10 | ″ |
| Carbon content of OA-4 | 11 | % (wt/wt) |
| Carbon content of OA-4 | 132 | g carbon/liter |
| Carbon added per cup | | |
| Low rate | 66 | mg carbon/cup |
| High rate | 1318 | |
| Carbon added per unit soil | | |
| Low rate | 330 | mg carbon/kg soil |
| High rate | 6591 | |

As shown in Table 5, about 330 mg C/kg soil was applied in OA-4 at the low rate. FIG. 10 shows that the amount of CO₂ evolved was variable and depended on soil type. In two of the soils (Tulare and Monterey), the treatment effect was less than 330 mg C/kg soil. This is suggests that the source of the carbon (NDRS vs. soil organic matter) was inconclusive.

However, in the Monterey soil, the difference in CO₂ evolution between OA-4 and the untreated control was >400 mg C/kg soil at 45 days Since this was greater than the total amount applied as OA-4 the source of at least some of this carbon was the soil organic matter. This confirms that OA-4 acted as stimulant or “primer” of soil microorganisms, the activation of which caused a release of carbon. This stimulation of soil microbes is also a strong indication of immobilization, which causes a labile pool of nitrogen, held in living and subsequently decaying microbial biomass, which is slowly released over time and becomes plant available.

In the case of the high NDRS application rate, Table 5 shows that 6,591 mg C/kg soil was added. In no case did CO₂ evolution exceed this level, therefore it could not be determined whether the C source for CO₂ evolution was the NDRS, the soil organic matter, or some combination of the two.

### Conclusion

The results of this study support the conclusion that the NDRS stimulates soil microorganisms which release CO₂ during their growth and maintenance respiration. In at least one case, there was a clear “priming effect” of NDRS, where the soil microbes were stimulated to consume carbon from native soil organic matter, which they did not consume in the absence of the NDRS.

Microbial activity was significantly stimulated by both NDRS formulations, at both low and high rates. Such microbial activity is expected to have a positive impact on immobilization of mineral nitrogen, which in turn would reduce the potential for leaching in soils treated with NDRSs.

### Example 6

### Urea Dialysis

Urea is known to disrupt hydrogen bonds in protein biochemistry. It can act as both a H-bond donor and acceptor. In agriculture, urea is a commonly applied nitrogen fertilizer. NDRSs might be beneficial in slowing the conversion of urea to ammonium ion and eventually to nitrate or to NH₃. Results show that urea interactions are more pronounced with NDRSOA-4 as compared to control.

### Methods

In this experiment dialysis was used to measure the interaction of urea with OA-4.

Dialysis Materials
Spectrum Labs Part No: G235061, 100-500 MW cutoff dialysis membrane

Solutions

1. A control solution of base, a chelating agent and water at similar concentrations to OA-4. (Equivalent to OA-4 without any humic extract).

2. OA-4

Dialysis Conditions

The starting conditions for dialysis were as shown in Table 6.

TABLE 6

| | Dialysis Chamber | Counter Buffer |
|---|---|---|
| NDRS | Starting | Starting |
| Solution | Concentration | Concentration |
| Control | 0.8 g/L of Control and 4.27 g/L of Urea | 0.8 g/L of Control |
| OA-4 | 0.8 g/L of OA-4 and 4.27 g/L of Urea | 0.8 g/L of OA-4 |

The concentration above is equivalent to 20 lbs of Control/OA-4 in 3000 gallons and 50 lbs of nitrogen in 3000 gallons of water.

### Urea Quantitation

A Urea Assay Kit (Bioassay Systems, DIUR-500) utilizing an improved Jung Method was used to quantify Urea. Samples at each time point were run in triplicate.

### Detailed Experimental Protocol

### Section 1: Preparing Solutions

### 1. OA-4 1: 10 g of OA-4

### 2. OA-4 2: Positive Control

Volumetric was used for preparation (equivalent to 20 lbs in 3000 gallons).

Solution has a pH below 9. If needed, a few drops of HCl were added.

| OA-4 1 | Ultra Pure Water |
|---|---|
| 2.388 g | 3 L |

### 3. OA-4 3: Dialysis Buffer

Volumetric was used for preparation (equivalent to 71 mM Urea Solution, or 107.25 lbs Urea in 3000 gal, or 50 lbs N in 3000 gal). Solution has a pH below 9. If needed, a few drops of HCl were added.

| OA-4 1 | Urea | Ultra Pure Water |
|---|---|---|
| 0.08 g | 0.427 g | 100 mL |

4. Solution 1: Control solution

### 5. Solution 2: Positive Control

Volumetric was used for preparation (equivalent to 20 lbs in 3000 gal). Solution has a pH below 9. If needed, a few drops of HCl were added.

| Control 1 | Ultra Pure Water |
|---|---|
| 2.388 g | 3 L |

### 6. Solution 3: Dialysis Buffer

Volumetric was used for preparation (equivalent to 71 mM Urea Solution, 107.25 lbs Urea in 3000 gal, or 50 lbs N in 3000 gal). Solution has a pH below 9. If needed, a few drops of HCl were added.

| Solution 1 | Urea | Ultra Pure Water |
|---|---|---|
| 0.08 g | 0.427 g | 100 mL |

Section 2: Prepare a Float-A-Lyzer for each solutions.
1. 10% (v/v) Isopropanol Solution (IPA). The solution was added to the Float-A-Lyzer.
2. The IPA filled Float-A-Lyzer was soaked in a 50 mL tube with IPA for 15-20 minutes.
3. The Float-A-Lyzer was washed with ultrapure water and soak in ultrapure water for 1-2 minute.
The IPA solution removes glycerin and allows for maximum membrane permeability.

### Section 3: Dialysis

### 1. OA-4

a. A 500 mL graduated cylinder was filled with 450 mL of OA-4 2.
i. Theoretical Equilibrium Concentration: 1.5 mM

b. 100 μL of OA-4 2 was collected. Time 0 sample (TO).

c. 100 μL was collected of OA-4 3. Standard (CO).

d. Float-A-Lyzer was filled with 10 mL of OA-4 3.

e. Float-A-Lyzer was then placed in 450 mL graduated cylinder.

f. OA-4 2 was stirred during dialysis.

g. A 100 μL sample was collected from the graduated cylinder after 4, 8, 10, 26, 28, 30, 32, and 34 hours.

| | Time |
|---|---|
| Sample | (Hours) |
| C0 - Dialysis Buffer | 0.0 |
| T0 - Counter Buffer | 0.0 |
| T1 | 4.0 |
| T2 | 8.0 |
| T3 | 10.0 |
| T4 | 26.0 |
| T5 | 28.0 |
| T6 | 30.0 |
| T7 | 32.0 |
| T8 | 34.0 |
| C1 - Chamber Solution | 34.0 |
| C2 - Chamber Solution | 34.0 |

h. After the last collection from the graduated cylinder (T8), two full pipette samples were collected from inside the dialysis chamber.

i. Samples placed in Refrigerator until analysis.

j. Repeated three times.

### 2. Control

a. A 500 mL graduated cylinder was filled with 450 mL of Solution 2.
i. Theoretical Equilibrium Concentration: 1.5 mM

b. 100 μL was collected of Solution 2. Time 0 sample (T0).

c. 100 μL was collected of Solution 3. Standard (C0).

d. Float-A-Lyzer was filled with 10 mL of Solution 3.

e. Float-A-Lyzer was placed in 450 mL graduated cylinder.

f. Solution 2 was stirred during dialysis.

g. A 100 μL sample was collected at the same time as OA-4.

h. After the last collection from the graduated cylinder (T8), two full pipette samples were collected from inside the dialysis chamber.

i. Samples placed in Refrigerator until analysis.

j. Repeated three times.

### Results

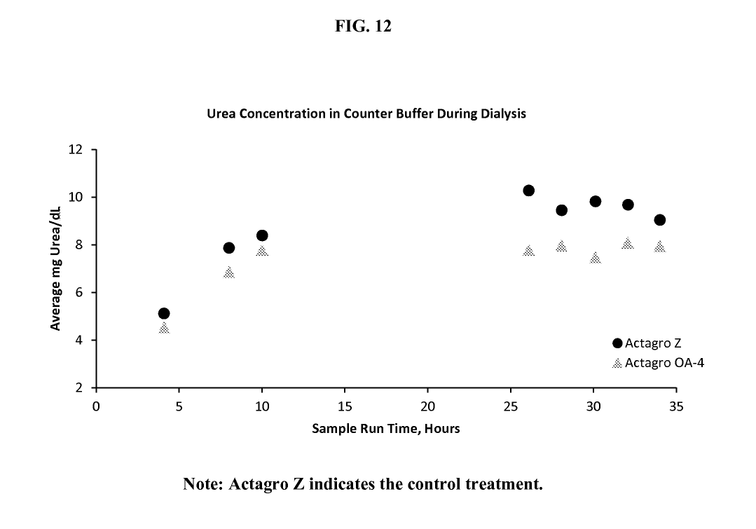

The control and OA-4 dialysis experiments were both run in quadruplicate. The results in FIG. 12, after removal of outliers, show that at equilibrium OA-4 has less urea in the counter buffer. This indicates that there is a larger interaction between urea and OA-4 than urea and control. It is contemplated that the nature of the preferential interaction between urea and OA-4 could be due to hydrogen bonding, van der Waals forces or a combination of both non-covalent interactions.

### Statistical Analysis

As shown in Table 7, the difference between the control solution and OA-4 at equilibrium is statistically significant (i.e., not due to random error). Table 7 displays the P-value for the T-Test, which is very low.

TABLE 7

| Test Question | P-Value |
|---|---|
| Control vs OA-4 | 4.683 × 10⁻⁶ |

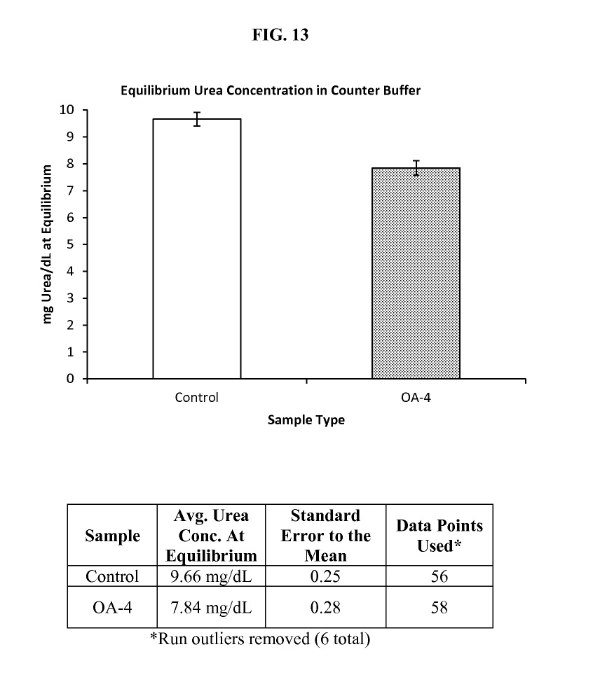

FIG. 13 shows the average equilibrium urea concentration in the counter buffer using 5 time points (26, 28, 30, 32, & 34 hours). Error bars were calculated as standard error to the mean.

### Conclusion

Equilibrium dialysis data clearly shows that urea interactions are more pronounced in OA-4 compared to control. The preferential interaction of urea with OA-4 was measured by quantifying the amount of urea in the counter buffer at equilibrium. Due to molecular interactions with OA-4, urea has a lower concentration in the counter buffer at equilibrium.

### Example 7

### Nitrogen Mineralization, Immobilization, and Nitrification in Soils Amended With Nutrient Depletion Reducing Substance

A vial study was conducted using a ¹⁵N isotope dilution technique in soils treated with OA-4 over 3 days of incubation showed that NDRSs increase nitrogen immobilization by from about 200 to about 340%.

### Materials and Methods

### Soil Type

Four surface soils from Fresno County, Monterey County, Tulare County, and Kern County were collected from the upper 12 inches of soil. The soils were passed through a 2 mm screen and homogenized. Before starting the experiments, samples were preconditioned with water or with 0.2% of OA-4 and incubated at 25° C. for 1 week.

Soils treatments consisted of:

1. untreated control,

2. soil treated with 50 μg NO₃-N/kg soil (applied as KNO₃ solution),

3. soil treated with 0.2% OA-4 plus 50 μg NO₃-N/kg soil (applied as KNO₃ solution), and

4. soil treated with 50 μg NH₄-N/kg soil (applied as (NH₄)₂SO₄).

The gross rates of N mineralization (m), consumption (c), and nitrification (n) were determined using laboratory isotope dilution procedures. In brief, 50 g dry soil was placed in a 500 mL flask with 10 mL deionized water, covered, and incubated at 22° C. for 3 d. After incubation, 25 mL of an N-15-labeled (NH₄)₂SO₄ solution or a KNO₃ solution were added to obtain an application rate of 50 μg N g⁻¹ soil. The flask was immediately placed on a magnetic plate, stirred for five minutes using a magnetic stirrer. One-half of the samples were extracted with 2 M KCl extraction solution. The NH₄⁺-N and NO₃⁻-N in the soil-solution mixture were determined. Another extraction was done after three days of incubation. A known amount of the filtrate (20 mL, determined gravimetrically) was used for the determination of ¹⁵N by a known diffusion procedure (see the methods described by the UC Davis Stable Isotope Facility). The ¹⁵N and ¹⁴N were determined by a GC-MS isotope analyzer. Throughout the experiment, the samples were aerated twice a day by removing the cover and shaking the flasks for a few minutes. Untreated soil samples (without addition of nitrogen) were also extracted as described above to measure the background ¹⁵N enrichment.

Gross rates of nitrogen mineralization were determined by NH₄⁺ isotope dilution, and gross rates of nitrification were determined by NO₃− isotope dilution methods as described by Davidson et al. (Davidson, E. A., et al. Ecology 1992, 73:1148-1156).

### Isotope Dilution Calculations

The following equations of Kirkham and Bartholomew (1954) were used:

$$\begin{matrix}m = \frac{{M}_{0} - {M}_{1}}{t} \times \frac{log ( {H}_{0} {M}_{1} / {H}_{1} {M}_{0} )}{log ( {M}_{0} / {M}_{1} )} & ( 1 ) \\ c = \frac{{M}_{0} - {M}_{1}}{t} \times \frac{log ( {H}_{0} / {H}_{1} )}{log ( {M}_{0} / {M}_{1} )} & ( 2 )\end{matrix}$$

where M₀=initial ¹⁴⁺¹⁵N pool (μg N g⁻¹ dry soil)

M₁=post-incubation ¹⁴⁺¹⁵N pool (μg N g⁻¹ dry soil)

H₀=initial ¹⁵N pool (μg N g⁻¹ dry soil)

H₁=post-incubation ¹⁵N pool (μg N g⁻¹ dry soil)

m=mineralization rate (μg N⁻¹ soil d⁻¹)

c=consumption rate (μg N g⁻¹ soil d⁻¹)

t=time (1 d for the present study)

and where m≠c. Kirkham & Bartholomew (1954) provide another equation for the condition when m=c, which was not encountered in this study.

For NH₄⁺-N transformation, m and c are used. For NO₃-N, n (nitrification) is used instead of m. The NH₄⁺ immobilization rate is then determined by subtracting the gross nitrification rate from the gross NH₄⁺ consumption rate. The gross NO₃-consumption rate is equivalent to the gross rate of NO₃-immobilization. Further details for the experiment are as follows.

Protocol for Diffusing Inorganic N to Determine ¹⁵N/¹⁴N by Mass Spectrometry

### Reagents

a. Preparation of ¹⁵N solutions: (purchased from Aldrich Chemistry, St. Louis, Mo., USA. ¹⁵N—KNO₃; ¹⁵N-(NH₄)² SO₂).

b. Preparation of 100 mg N/L as KNO₃:

687.5 mg of KNO₃ was dissolved in 1 L deionized water

c. Preparation of 100 mg N/L as (NH₄)₂SO₄

456.1 mg of (NH₄)₂SO₄ was dissolved in 1 L deionized water

d. Preparation of 2 M KCl solutions:

149.1 g of KCl was dissolved in 1 L or 298.2 g in 2 L.

### Incubation

a. A field-moist sample (50 g soil) was placed in a 250 mL bottle.

b. 10 mL deionized water was added to the 4 control bottles, which were then covered, and incubated at room temperature for 24 hours.

c. 10 mL of OA-4 solution having a concentration of 10 mg OA-4/mL deionized water was added, the bottle covered and incubated at room temperature for 24 hours, resulting in a 0.2% OA-4 in soil.

d. After incubation for 24 hours, 25 mL of 100 mg N/L of ¹⁵N labeled (NH₄)₂SO₄ or KNO₃ solution was added to obtain an application rate of 50 μg N/g soil at 99% ¹⁵N.

e. 25 mL of 100 mg N/L was applied to 50 g soil.

### Extraction

The soils were extracted with 2 M KCl after one minute (Time zero) and one week. For the extraction, 100 mL 2 M KCl was added to the soil, the bottles placed on a shaker for 10 minutes and the extract filtered. Take 50 mL subsample for NH₄⁺-N and NO₃⁻-N analyses. 20 mL of the extract was used for the ¹⁵N diffusion procedure described below.

### Diffusion

2.5 M KHSO₄ (10 μL/sample) prepared by carefully adding 7 mL of concentrated H₂SO₄ to 50 mL deionized H₂O; add 22 g K₂SO₄, adding more deionized H₂O; mixing until salt is dissolved; bringing to 100 mL final volume.

Devarda's Alloy (0.4 g/sample, KCl only), finely ground (40-mesh) MgO (0.2 g/sample)

Concentrated H₂SO₄

Concentrated NaOH (1:1 NaOH:H₂O by weight)

### Diffusion Procedure

1. Before diffusing, the reagents were measured to achieve:

a. 20-100 μg N at 10-30 atom %

b. 100-200 μg N at 1-10 atom %. 2. A filter disk was placed on the pin.

3. 5 μL of 2.5 M KHSO₄ was pipetted onto the disc. (trapping capacity is 350 μg N total; never exceed 50-60% of this).
4. The pin was placed in the glass culture tube.
5. The tube was simultaneously placed with the pin/filter paper and 1 scoop MgO (or stronger base, if diffusing digests) and/or devarda's alloy (see below) into specimen cup containing 20 mL sample. This was capped immediately and swirled.
6. Samples allowed to diffuse for 6 days at room temperature (22° C.), swirled daily.
7. After diffusing, the trap was removed from the sample with forceps, rinsed with deionized water into a specimen cup, placed on blotting paper, and dried in a desiccator with concentrated H₂50₄ for 4 h. After drying, both disks were wrapped in a 5×8 mm tin capsule.

For samples to be diffused for ¹⁵NH₄: 0.2 g scoop of MgO was added. For sample to be diffused for ¹⁵NO₃: 0.2 g scoop of MgO was added, mixed (swirled), and left open for 4 days. The reaction vessel was mixed daily thereafter to allow NH₃ to escape. After 5 days, 0.4 g Devarda's Alloy and 0.2 g of MgO was added along with an acid trap. The reaction vessel was capped and mixed daily, then left to sit for 6 days.

### Extraction/Digestion/Diffusion Blanks

Diffuse extraction blanks as though they were samples. Determine the mass of N diffused by adding up all the beams on the mass spectroscopy output. For KCl extracts, 3 blanks for each batch of KCl used were run.

Standards-General considerations
Make 2 types of standards: diffused standards and non-diffused standards.
Non-Diffused Standards: Use the stock solution

1. Place a filter paper disk onto a stainless steel wire and place in tube.

2. Pipette 5 μL of 2.5 M KHSO₄ onto each disk.

3. Pipette in enough 10,000 ppm stock to provide the desired mass of N.

a. For standards to receive=60 μg N, pipette half of the total volume of standard stock solution onto each disk.

b. For standards to receive=50 μg N, pipette the entire volume of standard stock solution onto the top disk.

4. Dry in dessicator over conc. H₂SO₄ overnight and wrap in both disks into one tin capsule.

Diffused Standards: Dilute the stock solution by 10

1. Make a 1,000 ppm (1,000 mg N/L) solution from the 10,000 ppm stock.

2. Measure out a 40 ml volume of 2 M KCl for each standard.

Pipette in enough 1,000 ppm standard to provide the desired mass of N.

### Results and Discussion

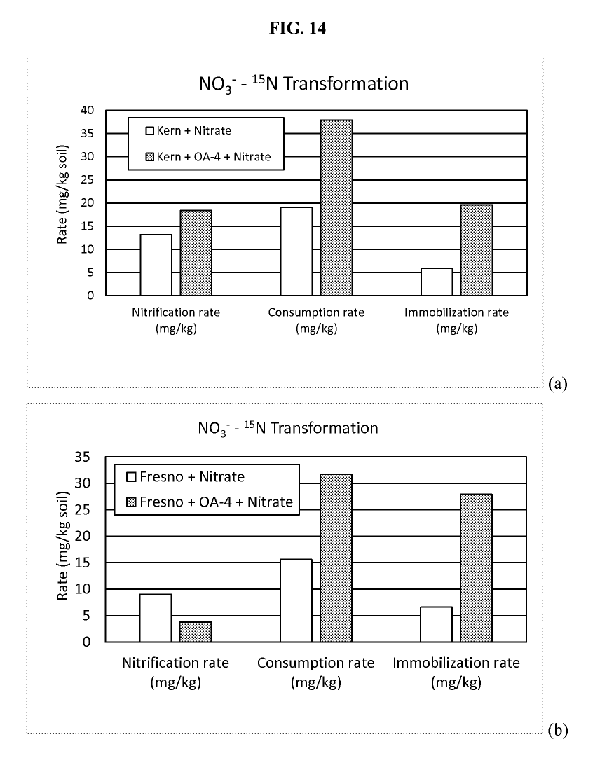

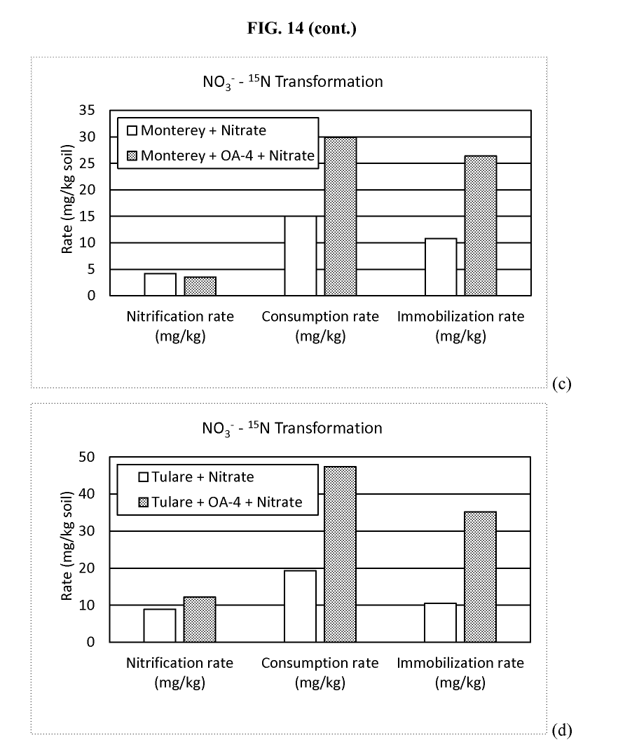

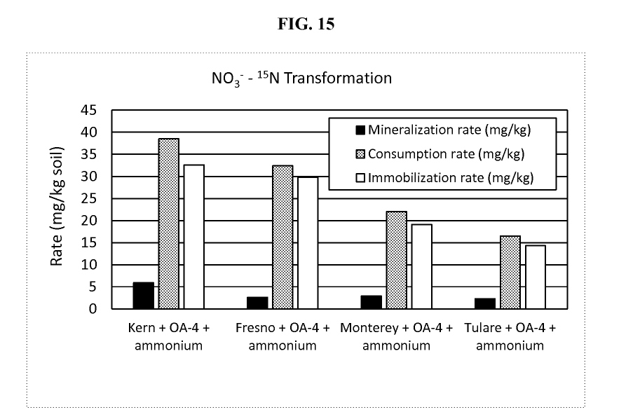

FIG. 14, panels a-d, and Table 8 show nitrogen transformation after application of 50 mg N/kg soil of ¹⁵N labeled K₂NO₄ to soils preconditioned with and without OA-4. FIG. 15 and Table 9 show nitrogen transformation after application of 50 mg N/kg soil of ¹⁵N labeled (NH₄)₂SO₄ to soils preconditioned with OA-4. Raw data and calculations are in Table 9.

Gross rate of NO₃⁻ immobilization in soils amended with OA-4 was more than 200 greater than immobilization in soils without OA-4. The gross rate of NH₄′ immobilization in soils amended with OA-4 was from about 5 to more than about 10 times greater than the mineralization rate across soil types.

TABLE 8

| | Nitrifi- | Consump- | Immobi- |
|---|---|---|---|
| | cation | tion | lization |
| | rate | rate | rate |
| Treatment | (mg/kg) | (mg/kg) | (mg/kg) |
| Kern + Nitrate | 13.2 | 19.1 | 5.9 |
| Kern + OA-4 + Nitrate | 18.4 | 37.9 | 19.6 |
| Fresno + Nitrate | 9.0 | 15.6 | 6.6 |
| Fresno + OA-4 + Nitrate | 3.8 | 31.7 | 27.9 |
| Monterey + Nitrate | 4.2 | 15.0 | 10.8 |
| Monterey + OA-4 + Nitrate | 3.5 | 29.9 | 26.4 |
| Tulare + Nitrate | 8.9 | 19.3 | 10.5 |
| Tulare + OA-4 + Nitrate | 12.2 | 47.4 | 35.2 |

TABLE 9

| | Mineral- | Consump- | Immobi- |
|---|---|---|---|
| | ization | tion | lization |
| | rate | rate | rate |
| Treatment | (mg/kg) | (mg/kg) | (mg/kg) |
| Kern + OA-4 + ammonium | 5.9 | 38.5 | 32.6 |
| Fresno + OA-4 + ammonium | 2.6 | 32.4 | 29.8 |
| Monterey + OA-4 + ammonium | 2.9 | 22.0 | 19.1 |
| Tulare + OA-4 + ammonium | 2.3 | 16.5 | 14.3 |

The carbon to nitrogen (C:N) ratio of organic material decomposing in soil is only an approximate indicator to net nitrogen mineralization, largely because the elemental ratio takes no account of the rates at which the different forms of carbon and nitrogen in the organic material (e.g., carbohydrates, lignin, etc.) become available to microorganisms. Changes in net mineralization may arise from differences in gross nitrogen mineralization or immobilization or loss or all three. Gross nitrogen mineralization is primarily determined by the amount and availability of nitrogen in soil organic matter, while immobilization is largely a function of the available carbon.

In this study, the greater immobilization rates than mineralization (or nitrification) rates indicated that application of OA-4 may have solubilized some of the native soil organic carbon (priming effect) and resulted in a larger C:N ratio than 9/1, which induced immediate immobilization.

### Example 8

### Effect of A NDRS Nutrient Depletion Reducing Substance Plus UAN on Reducing Nitrogen Losses From the Soil

### Introduction

This study was conducted to determine the efficacy of OA-4 added to UAN on reducing nitrogen losses in the field in corn. Products were applied at specific timings to determine which treatment produced highest yields, best stand, and best plant vigor, and what effect upon soil nitrogen, in particular, soil nitrate, which is frequently a source of significant nitrogen loss from agricultural soils. Based on the data, it is contemplated that one or more of the following occurs:

OA-4 reduces nitrogen losses.

OA-4 reduces the nitrification rate.

OA-4 reduces the potential for denitrification.

OA-4 reduces the size of NO₃⁻ pool in soil.

OA-4 reduces leaching of NO₃⁻.

OA-4 slows urease activity.

OA-4 forms complexes with, and or adsorbs to NO₃⁻ to slow its leaching loss in the soil profile.

OA-4 increases immobilization (the adsorption of mineral nitrogen into soil microbial biomass).

More nutrients are available to the crop with OA-4 treatment.

OA-4 increases N concentration in crop biomass.

OA-4 increases total N content (mass of N) in crop biomass.

OA-4 increases crop growth.

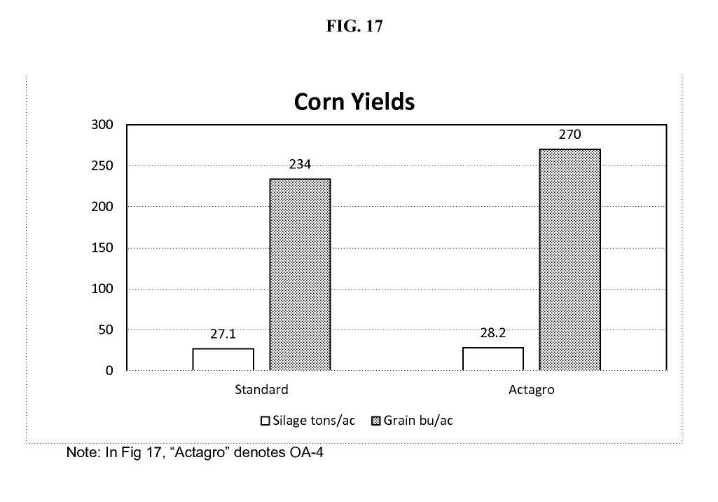

OA-4 increases crop yield (FIG. 17).

### Materials and Methods

A. Site Location: Whitewater, Wisconsin, Jefferson County

B. Test Crop: Grain Corn
Variety: Dairyland DS-9303 RR/YG/CB/RW
Planting Date: May 10, 2014

C. Plot Description:
Field Size: 26 acres
Plot Size: 10′×50″-0.11 Acres
Cultural Practices: Rain Fed
Soil: Milford Silty Clay Loam

D. Experimental Design: Randomized Complete Block (RCB) 1 factor study

E. Replication No. and Units: Four

F. Treatments: A standard application of 3 gal/acre ammonium polyphosphate was applied to the entire trial area to act as a pop-up fertilizer for field and crop uniformity. The components were applied to the soil at the following rates using a plot tractor.
1. Control−Grower Standard

| | | |
|---|---|---|
| UAN 28 | 40 | Lb. N/Ac starter (at planting) |
| UAN 28 | 75 | Lb. N/Ac sidedress at V3-V4* |
| UAN 28 | 35 | Lb. N/Ac surface dribble at V6 |

2. Actagro+Standard N (at same timings as shown above)

| | | |
|---|---|---|
| UAN28 | 40 | Lb. N/Ac |
| +OA-4 | 1.6 | Gal/Ac |
| UAN28 | 75 | Lb. N/Ac |
| +OA-4 | 3 | Gal//Ac |
| UAN28 | 35 | Lb. N/Ac |
| +OA-4 | 1.4 | Gal/Ac |

*V3, V6 etc. is a standard measure of the corn crop's development stage, as measured by leaf number. V3 means the corn, on average, has 3 emerged leaves, V6 means there are 6 leaves, etc.

(At each application, the rate of OA-4 was 4 gallons/100 lbs N. The low rate of OA-4 was equivalent to about 1 mL/100 gram soil or a little more than 1 mg PR/100 gram soil)

G. Test Procedures: The treatments were replicated four times and randomized using randomized complete block design. Plot size was 10′×50′

H. Sampling Procedures:
Stand Count: Stand was counted from the plot and converted to an acre basis at pre-V3 application, VT (VT=tasseling stage of corn) and Harvest to ensure yield differences were not from plant population differences.
Vigor: Vigor was evaluated visually at pre-V3 application, pre-dribble and VT. Vigor was also evaluated through regular (3 growth stages) plant biomass measurements.
SPAD: A SPAD-502 (Spectrum Technologies, Aurora, Ill., USA) reading was taken at pre-V3 application, pre-dribble and VT to evaluate leaf chlorophyll concentration.
Yield: Silage yield was obtained from one half of each plot when plants dried down to 65% moisture. Plots were harvested with an adapted Cub Cadet Brush chipper. Yield was taken at grain harvest on Nov. 10, 2014 with a Case-IH 2144 plot combine with a 1043 corn header and analyzed using Harvest master HCGG/Allegro. Moisture percentage and test weight were taken along with yield in lbs/acre.

### Results and Discussion

Typical N losses from placement of UAN applications are considered minimal, unless environmental conditions favoring denitrification, leaching of nitrate or ammonia volatilization are severe. In Midwestern soils, 1″ of rainfall can move nitrate 6″.

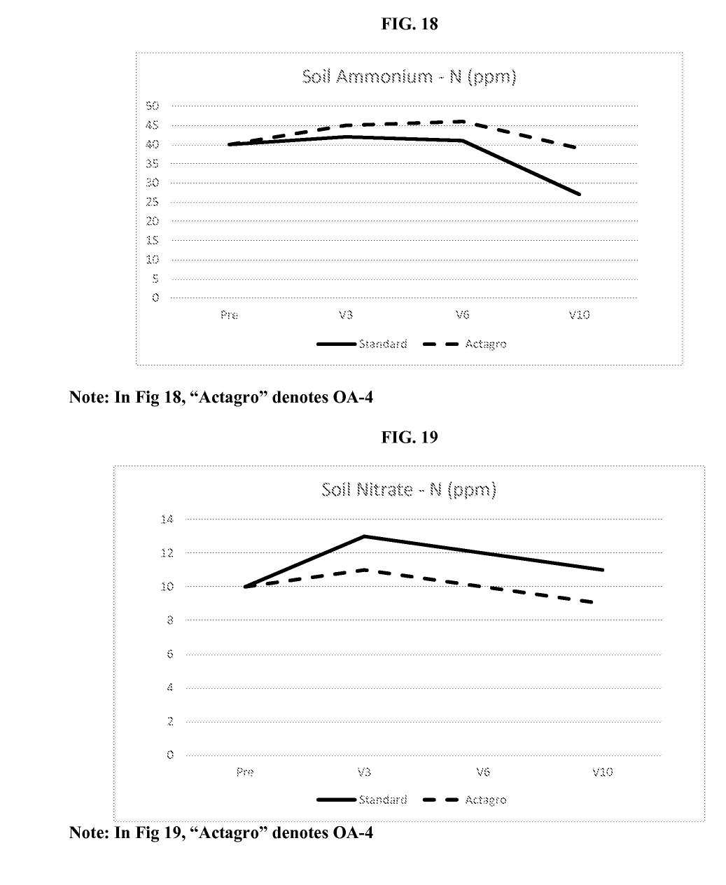

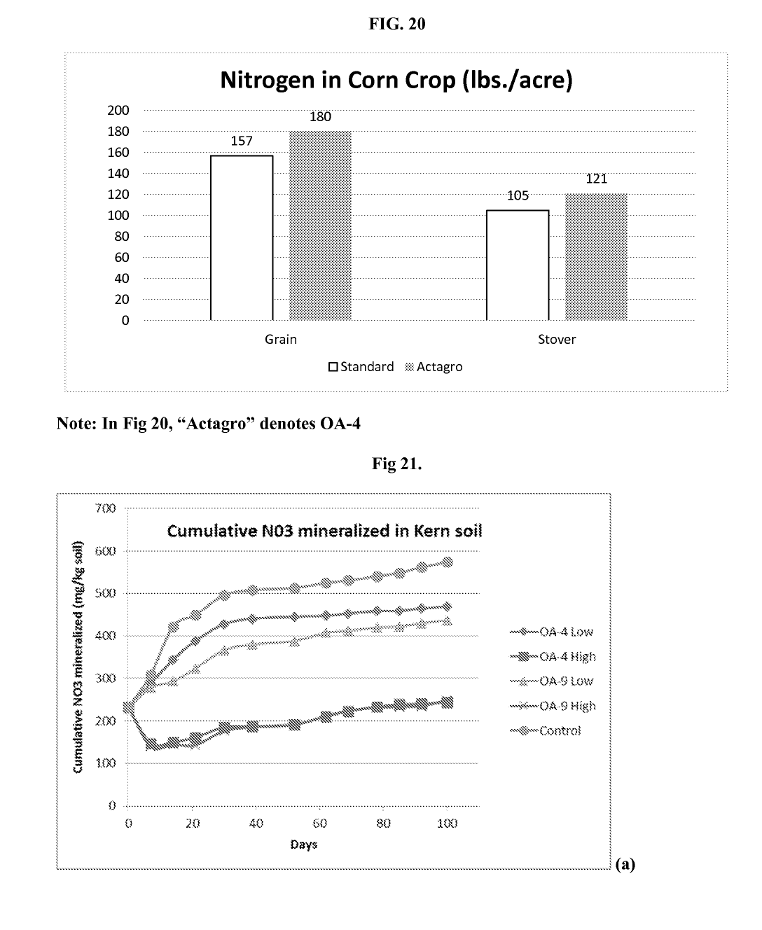

Pretreatment soil samples showed no differences in NH₄+ or NO₃⁻ levels (FIGS. 18 and 20). Soil samples in late May (influenced by the starter treatment) showed an increase in available soil ammonium nitrogen from OA-4 treatment, with the grower standard samples containing more NO₃-N (FIG. 19). It seems likely that nitrification was delayed or reduced &/or urease was inhibited with the OA-4 treatment. There was also a concomitant decrease in the soil nitrate levels in the OA-4 treatment which may confirm this effect. Less soil Nitrate N could be a result of greater plant uptake of available nitrogen, or other mechanisms. After the second N application and prior to the third N application in late June, samples (influenced by the side-dress treatment) again showed an increase in available soil ammonium nitrogen from the OA-4 treatment, with the grower standard samples containing more NO₃-N. These results demonstrate that OA-4 is directly associated with reduced soil nitrate levels. This could indicate a change in urease activity, a delay in nitrification, greater nitrate uptake, some combination of the above, or other factors. As with the previous soil samples, an increase in available soil ammonium nitrogen from the OA-4 treatment was observed, with the grower standard samples containing more NO₃-N.

The third set of soil samples were taken 1 week in advance of the beginning of the crop's reproductive growth phase. Because the third application was surface applied, ammonia volatility from the UAN may have occurred. Ammonia flux appears to not have been excessive, even from the standard treatment, as no phytotoxicity was recorded. Reduction in ammonia volatilization could have occurred in addition to the other potential fates of nitrogen mentioned previously increasing the difference between soil NH₄ between treatments to the greatest amount of the 3 post treatment samplings. Available N in the soil for crop growth was significantly increased continued through the VT stage of crop development, over 2 months after corn planting. Through July, we see significantly more available N in the ammonic form (NH₄⁺), than control in the soil in these 14″ deep samples. Even with the slightly higher NO₃⁻ levels in the control soil samples, there was about 45 lbs more N/acre with the OA-4 treatment going into tasseling.

Additional available soil N translated into higher plant tissue N at the 3 timings leaf sampling was performed. Higher plant and soil N translated into greater plant biomass at the 3 biomass samplings. A quick calculation of biomass times nitrogen content of the dry matter reveals a greater uptake of nitrogen with the OA-4 treatment.

Two types of corn yields were measured; one for silage and one for grain. Both silage yield and silage yield adjusted to 65% moisture were significantly greater than control. Corn grain yield was significantly greater than the grower standard as well.

Total N uptake by the crop is calculated by grain yield at a constant N content plus the nitrogen in the stover remaining after harvest. Based upon the International Plant Nutrition Institute (IPNI) plant nutrient uptake calculator, the OA-4 treated Corn removed 39 pounds more nitrogen per acre than the standard control (FIG. 20).

The calculation is as follows:

Increased nitrogen in grain=180−157=23

Increased nitrogen in stover*=121−105=16 (Stover is the aboveground biomass of the corn, excluding the grain portion).

Total nitrogen increase=23+16=39 lbs N/acre.

It can be stated alternatively that this amount of nitrogen was lost from the soil-plant system in the grower standard, compared to the OA-4 treatment.

At tasseling, when 30% of the crop's N need remains to be taken up, the grower standard UAN had 44 lbs/acre less mineral N available than the OA-4 treatment NDRS. Therefore, there was a greater depletion of soil N measured in the grower standard.

The OA-4 material added to conventional N and applied in an acknowledged efficient manner resulted in a significant reduction of N loss to environmental factors and a consequent increase in nitrogen uptake by the crop (about 15% increase in nitrogen uptake by the crop). This increased retrieval of N from the soil increased yield and reduced N free in the soil to be lost before the next crop is planted.

### Example 9

### Effect of OA-4 on Potential Surface Runoff-Phosphorus and Nitrogen Levels in Surface Soil

The nutrients phosphorus and NH₄⁺ are not normally lost to leaching into groundwater. However, it is known that surface runoff during soil erosion events is a significant source of phosphorus and NH₄⁺ pollution of surface waters. When runoff/erosion occurs, both the soil material, which contains adsorbed nutrients, as well as the water that carries them, moves nutrients laterally into surface waters adjacent to agricultural sites. This is a concern for phosphorus, NH₄⁺ and NO₃⁻. Prior research has demonstrated that soil phosphorus runoff likelihood was found to be closely correlated to the standard agricultural soil tests appropriate for the soil pH range (Bray or Olsen's). It was only necessary to analyze the top 2 cm of soil for P in order to predict amount of dissolved reactive phosphate (DRP or runoff P) in runoff. (Bundy, Larry G. Understanding Soil Phosphorus [Powerpoint slides]. Retrieved from http://www.soils.wisc.edu/extension/materials/P_Understanding.pdf; also: Allen, B. L. et al. Soil and Surface Runoff Phosphorus Relationships for Five Typical USA Midwest Soils (2006). J. Environ. Qual. 35:599-610). The objective of this experiment was to measure the extent to which OA-4 can reduce the amount of phosphorus and/or NH₄⁺ in surface runoff.

Methods

Tranquillity Clay soil was screened to 2 mm and mixed very well with an equal weight of fine sand for improved drainage. Coarse sand and a cellulose filter were placed at the bottom of each cup for air flow. Cups are 500 ml Nalgene Rapid Flow vacuum filter units. Soil was packed into cups with a pestle for a Bulk Density of 1.4 g/cc.

Prior to adding treatments, samples were preconditioned with 0.01M CaCl₂ and incubated at 77° F. for 7 days.

All treatments were added to a soil surface roughened to 1 cm.

Treatments:
1) 18-46-0 @500 lbs/acre (90 lbs N and 100 lbs P/acre respectively) then 1000 gal/ac water
2) OA-4 10 gal/ac+990 gal/ac water over 18-46-0 @500 lbs/acre
3) No Fertilizer Control (OA-4 10 gal/ac+990 gal/ac water)
1. 0.42 g of 18-46-0 prills for each cup, were ground in portable coffee grinder to medium fine powder.
2. Powdered fertilizer prills were spread uniformly over soil surface for Treatments 1 and 2.
3. For Treatment 1, deionized water only at 7.03 ml/cup (1000 gal/ac) was spread uniformly over soil surface.
4. Deionized water was mixed with OA-4 for Treatments 2 and 3 and applied as No. 3 above.
5. Treatments sat on soil for 18 hours, then water applications (see 6. below) began.
6. To simulate a heavy rainfall, a dilute mixed chloride salt solution (K, Mg, Na) was applied in 5 increments over 2 hours. The 300 ml used for each cup approximated 2½″ of rainfall.
7. Soils were allowed to equilibrate and dry for 48 hours.
8. To sample, cups were inverted onto wax paper then righted for each of the three 2 cm depth increments to be removed from the one below it.
9. Each of the 3 depth segments of soil was analyzed for P, NH₄ and NO₃.

Results and Discussion

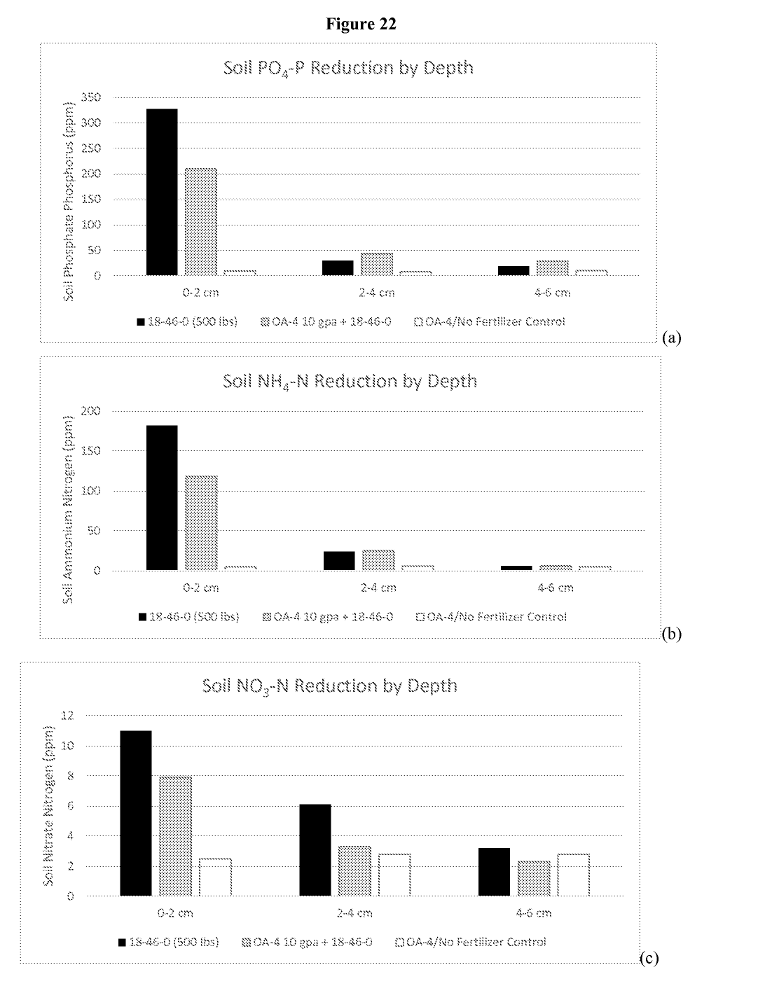

FIG. 22 shows nutrient concentration by nutrient, treatment and soil depth layer. In the figure, smaller values mean reductions in nutrient concentration. FIG. 22a indicates that OA-4 significantly lowered quantities of soil test phosphorus from the surface 2 cm of soil compared to the fertilizer only treatment. This test has been demonstrated to be highly correlated to the “dissolved reactive phosphorus” which is the problem for runoff into rivers and lakes. The lower

P content in the surface 2 cm of soil indicates reduced P runoff potential and associated reduction in nutrient depletion, in the presence of OA-4. Chemical bonding/interaction between the OA-4 and the fertilizer P would increase the mobility of P in soil, where it is widely considered to be immobile. Increased phosphorus mobility would increase its movement into the soil with water. Additionally, a statistically significant quantity of the fertilizer P was redistributed to the 2-4 cm depth, where it is recognized to not be a significant runoff concern. The P level with OA-4 treatment at the 4-6 cm level was not significantly different from the fertilizer only treatment, but was higher than the no fertilizer control. This suggested that fertilizer P moved below the runoff susceptible depth with OA-4 application. The fertilizer only treatment didn't differ significantly from the control. The 29% reduction of phosphorus in the location and form that is susceptible to run off the field is noteworthy in terms of reduced nutrient depletion.

Similar results were observed with ammonium (FIG. 22b). Lab data indicate that OA-4 removed significant quantities of ammonium from the surface soil compared to the fertilizer only treatment. As with phosphorus, this results in reduced N runoff potential and therefore reduced nutrient depletion. Ammonium is not considered to be readily leachable downward from the soil surface due to its interactions with cation exchange sites on soil particles. Binding of the OA-4 to the ammonium and limiting the exchange site interactions could explain the 35% reduction in average surface soil ammonium level. Some of the fertilizer N was also redistributed to the 2-4 cm depth, where it is recognized to not be a significant runoff concern. At the 2-4 cm depth, the N levels from with and without treatment were similar, but slightly higher than the control. The N levels at the 4-6 cm level were no different from the control. The ammonium results at the depths below 2 cm are neutral from the standpoint of nutrient depletion.

Nitrification, i.e., the transformation to NO₃⁻, of fertilizer N had begun by the end of this experiment. Both treatments with added N had higher levels of nitrate at the surface than the no fertilizer control (FIG. 22c). The 2-4 cm depth had least nitrate present with the OA-4+ fertilizer and no fertilizer control treatments. This was very favorable in terms of reducing nutrient depletion. Reduced NO₃⁻ under the OA-4 treatment compared to fertilizer alone indicates an immobilization of some nitrate by the OA-4. All nitrate levels were similar at 4-6 cm.

The performance of OA-4 to reduce both ammonium and phosphate in the most run off susceptible 0-2 cm depth of the soil column is strongly indicative of its ability to reduce fertilizer runoff from heavy rains or irrigations in field situations. These results are clearly supportive of the nutrient depletion-reducing properties of OA-4.

1. A method for controlling the depletion rate of a nutrient in soil, comprising applying a nutrient depletion-restricting substance (NDRS) and a fertilizer to soil or applying a NDRS to soil which has been fertilized, wherein the depletion of the nutrient was reduced by about 40 to about 80% by weight.

2. The method of claim 1, wherein the nutrient is nitrogen or phosphorous.

3. The method of claim 2, wherein the phosphorous is depleted due to runoff

4. A method of inhibiting nitrogen volatilization from soil, comprising applying a nutrient depletion-restricting substance (NDRS) and a fertilizer to soil or applying a NDRS to soil which has been fertilized, wherein the amount of nitrogen loss via volatilization is reduced by at least about 40% by weight after about 7 days after applying the nitrogen-based fertilizer at a temperature of about 15-30° C.

5. The method of claim 4, wherein the amount of nitrogen loss via volatilization is reduced by up to about 60% after 7 days after applying the fertilizer.

6. A method of increasing nitrate immobilization and/or mineralization in soil by at least about 25% after about 100 days, comprising applying a NDRS to soil at a concentration of at least about 1 milligram of NDRS per 100 grams of soil.

7. The method of claim 6, wherein the nitrate immobilization and/or mineralization is increased by at least about 50% after about 100 days.

8. The method of claim 6 or claim 7, wherein the immobilizing comprises inhibiting and/or mitigating transformation of nitrate (NO₃−) and/or ammonium (NH₄+) to nitrogen or ammonia gas.

9. A method of decreasing nitrate leachate from soil by at least about 50% after about 3 weeks, comprising applying a NDRS to soil at a concentration of at least about 1 milligram of NDRS per 100 grams of soil.

10. The method of claim 9, wherein the nitrate leachate from soil is decreased by at least about 50% after about 100 days.

11. The method of claim 10, wherein the amount nitrate leached from the soil is decreased by at least about 80%.

12. The method of claim 1, wherein the soil comprises about 30-70% sand, about 20-60% silt, about 10-25% clay and about 0.5 to 3% organic matter

13. The method of claim 1, wherein the soil comprises about 20-40% sand, about 30-50% silt, about 20-40% clay and about 0.5 to 5% organic matter.

14. The method of claim 1, wherein the NDRS is applied to the soil within a time period of from about 3 hours before to about 3 hours after applying a fertilizer.

15. The method of claim 14, wherein the NDRS is applied to the soil at substantially the same time as the fertilizer.

16. The method of claim 14, wherein the NDRS and the fertilizer are applied to the soil in an amount of from 2 Liters of NDRS per 100 kilograms of nitrogen or phosphorous in the fertilizer to about 150 Liters of NDRS per 150 kilograms of nitrogen or phosphorous.

17. The method of claim 16, wherein the NDRS and the fertilizer are combined prior to applying to the soil.

18. The method of claim 1, wherein the NDRS is applied to the soil by spraying, flooding, soil injection or chemigation.

19. The method of claim 14, wherein the fertilizer comprises ammonia, ammonium, nitrate and/or urea.

20. The method of claim 1 wherein the NDRS is applied to the soil in an amount of from about 5 Liters per hectare to about 15,000 Liters per hectare.
